(19) United States
(12) Patent Application Publication
(10) Pub. No.: US 2002/0016971 A1
(43) Pub. Date: Feb. 7, 2002

(54) Personal video recording system with home surveillance feed

(76) Inventors: David M. Berezowski, Tulsa, OK (US); William L. Thomas, Bixby, OK (US); Toby DeWeese, Tulsa, OK (US); Michael D. Ellis, Boulder, CO (US)

Correspondence Address: FISH & NEAVE, 1251 AVENUE OF THE AMERICAS, 50TH FLOOR, NEW YORK, NY, 10020-1105, US

(21) Appl. No.: 09/823,696

(22) Filed: Mar. 30, 2001

Related U.S. Application Data
(60) Provisional application No. 60/193,911, filed on Mar. 31, 2000.

(51) Int. Cl. H04N 7/173; H04N 7/18

(52) U.S. Cl. 725/105; 348/143

(57) ABSTRACT

A personal video recording system is provided that acquires real-time video and audio information in, and in the vicinity of, a user's home. Acquired video and audio information may be stored on a storage device included in user television equipment or at any other suitable location. Current information may be presented to the user in real-time. The user may also access stored information for playback. The user may use a guidance application to aid in the retrieval of information. The personal video recording system may provide a user interface to manipulate audio and video information. Information may be shared between multiple personal video recording systems. The personal video recording system may also be used for surveillance.

This application claims the benefit of U.S. provisional application No. 60/193,911 filed on Mar. 31, 2000, which is hereby incorporated by reference herein in its entirety.

### BACKGROUND OF THE INVENTION

This invention relates to personal video recording systems and, more particularly, to personal video recording systems that allow users to record real-life events in the users' homes and to play back the recorded real-life events using a playback guide.

Current video recording technology allows people to record real-life events with increasing ease. Video cameras are being manufactured as small as possible while providing for a substantial amount of functionality and quality of picture. Recently, video cameras have been developed that use digital technology to record pictures. Millions of people receive great joy using video cameras to catch moments on tape for posterity.

Typically, video cameras record pictures on removable storage media such as videocassettes or 8 mm tapes. To review the recorded video, users must transfer the removable storage media to their VCR or other playback device, or connect the video camera to the user's television using confusing and awkward cables. In addition, if the camera is not ready for some reason (e.g., it is not turned on, the battery is dead, etc.), the opportunity to obtain footage that the user would like to record is lost.

It is therefore an object of the present invention to provide systems and methods to provide for full-time recording of real-life events within a user's home and outside the perimeter of the user's home. It is also an object of the present invention to provide systems and methods that allow for a user-friendly presentation of stored and real-time video and audio feeds.

### SUMMARY OF THE INVENTION

These and other objects are accomplished in accordance with the principles of the present invention by providing a personal video recording system in which video and audio feeds may be stored on a storage device and presented via an output device.

A guidance application may also be provided to allow for user-friendly presentation of stored and real-time video and audio feeds. Video and audio feeds from audio/visual equipment (e.g., video cameras with microphones) may be installed in a users home. The real-time feeds from the audio/visual equipment may be presented via an output device that may be included in user television equipment. Audio/visual equipment may be installed in such a way so as to provide for more than one view of that area. The video and audio information for these views may be presented simultaneously.

The information from the real-time feeds may be stored on storage devices such as servers, web servers, home servers, digital video recorders (e.g., TiVo™, ReplayTV™), writeable DVDs, writeable CDs, hard disk drives, or any other suitable storage device for later playback and review. Video and audio information from auxiliary equipment (e.g., a hand-held video camera) may be downloaded to the personal video recording system.

The personal video recording system may also provide recording and editing functionality. Such recording and editing functionality may allow the user to splice clips of stored video into a compilation (e.g., highlights of a birthday party) or extract still shots from stored video. Recorded and edited clips, still shots and any other information may be named or otherwise identified as the user desires. Recorded information may automatically be date-stamped and time-stamped. The recorded and edited information may be stored and retrieved from any suitable location the user desires. Any suitable third party application may be used in conjunction with the personal video recording systems of the present invention.

The personal video recording system may also provide for suitable parental control or other lock-out features. Lock-out features may require verification or a password to lock and unlock certain stored video or both. For example, the audio and video information for a particular video camera may be locked. In another suitable embodiment, the audio and video information for a particular camera acquired during a certain time interval may be locked.

The personal video recording system may provide the user with the ability to access stored video and audio information with the aid of, for example, a guidance application. The guidance application of the present invention may provide a user-friendly interface for the user to access stored audio and video information. Audio and video information may be stored in any suitable way, such as by day, by time, by category, by name, by source, or by any other suitable method. For example, information may be organized in a hierarchical tree arranged by time. The user may be provided with the ability to navigate among the branches of such a tree. Upon navigating to stored information, the user may access (e.g., display and listen to) the stored information, rename the information, or move the information to another suitable location in the tree. The user may also be provided with the ability to download and process the information or perform any other suitable action upon accessing stored information.

Two geographically disparate user television equipment may share information using, for example, a dial-up connection or the Internet. By way of such an approach, information may be transferred from a first user television equipment to a second user television equipment. In another suitable approach, a storage device may be maintained at only one location. The system at a second location may transfer its real-time video and audio information to the storage device at a first location using any suitable approach (e.g., wireless, Internet broadcast).

A first user television equipment may also transfer information to a remote server (e.g., at a television distribution facility). Information stored at the remote server may be accessed by other user television equipment. In those cases in which information is to be transferred to and from user television equipment, verification such as a password may be required.

The personal video recording system may also be used for surveillance. For example, the personal video recording system may be synchronized with the user's home security system. When sensors, such as motion sensors, audio sensors, a door-open sensor, heat sensors, smoke sensors, carbon monoxide sensors, or weight sensors are tripped, audio and video equipment may begin recording. Audio and video equipment may record only at certain times (e.g., at night) or when a sensor has been tripped for a pre-determined period of time. When a sensor is tripped, an appropriate authority (e.g., police, fire department) may be notified. Information (e.g., an alarm signal, acquired information) may also be sent by the guidance application automatically to a home surveillance system. The guidance application may also automatically add a branch to the hierarchical organizational tree in response to information being acquired after a sensor is tripped. The branch may correspond to the information acquired in response to the sensor being tripped.

Further features of the invention, its nature and various advantages will be more apparent from the accompanying drawings and the following detailed description of the preferred embodiments.

### BRIEF DESCRIPTION OF THE DRAWINGS

FIG. 1 is a block diagram of an illustrative personal video recording system in accordance with the principles of one embodiment of the present invention.

FIG. 2 is a block diagram of an illustrative system showing how servers may be located at network nodes in accordance with the principles of one embodiment of the present invention.

FIG. 3 shows an illustrative display screen in which real-time information is presented to the user in accordance with the principles of one embodiment of the present invention.

FIG. 4 is a flow chart of illustrative steps involved in communicating information from a source and storing or displaying the information in accordance with the principles of one embodiment of the present invention.

FIG. 5 shows an illustrative display screen in which sources of information are presented to the user in accordance with the principles of one embodiment of the present invention.

FIG. 6 shows an illustrative display screen in which more than one view of the same area are presented to the user in accordance with the principles of one embodiment of the present invention.

FIG. 7 shows an illustrative display screen in which sources of information are presented to the user in accordance with the principles of one embodiment of the present invention.

FIG. 8 is a flow chart of illustrative steps involved in allowing a user to access real-time information and have the real-time information presented in accordance with the principles of one embodiment of the present invention.

FIG. 9 shows an illustrative display screen in which a user may select a link to general stored video or stored video from a particular source in accordance with the principles of one embodiment of the present invention.

FIG. 10 shows an illustrative display screen in which the user may navigate a hierarchically organized tree of stored information in accordance with the principles of one embodiment of the present invention.

FIG. 11A shows an illustrative display screen in which parental controls may be accessed in accordance with the principles of one embodiment of the present invention.

FIG. 11B shows an illustrative display screen in which a password may be requested to access locked information in accordance with the principles of one embodiment of the present invention.

FIG. 12 is a flow chart of illustrative steps involved in allowing a user to access stored information and have the stored information presented in accordance with the principles of one embodiment of the present invention.

FIG. 13 shows an illustrative display screen in which a link to record and edit information is provided in accordance with the principles of one embodiment of the present invention.

FIG. 14 shows an illustrative display screen in which a user is given the ability to edit information in accordance with the principles of one embodiment of the present invention.

FIG. 15 shows an illustrative display screen in which a user is given the ability to name information and sources of information in accordance with the principles of one embodiment of the present invention.

FIGS. 16A and 16B show illustrative display screens in which the user is given the ability to store information at any suitable location in accordance with the principles of one embodiment of the present invention.

FIG. 17 shows an illustrative display screen in which the user is given the ability to navigate a hierarchically organized tree of stored information in accordance with the principles of one embodiment of the present invention.

FIG. 18 shows an illustrative display screen in which a still shot may be presented in accordance with the principles of one embodiment of the present invention.

FIGS. 19A and 19B show illustrative display screens in which a “slide-show” may be presented in accordance with the principles of one embodiment of the present invention.

FIG. 20 shows an illustrative display screen in which the user is given the ability to navigate among scaled-down still shots in accordance with the principles of one embodiment of the present invention.

FIGS. 21A, 21B, and 21C are flow charts of illustrative steps involved in allowing the user to store information in accordance with the principles of one embodiment of the present invention.

FIG. 22 is a flow chart of illustrative steps involved in allowing remote user television equipment to access information on a first user television equipment in accordance with the principles of one embodiment of the present invention.

FIGS. 23A and 23B show illustrative display screens in which an item is added to a hierarchical tree in response to a sensor being tripped.

FIG. 24 is a flow chart of illustrative steps involved in recording information, communicating a signal to an appropriate authority, and transmitting information to a home surveillance provider when sensors are tripped in accordance with the principles of one embodiment of the present invention.

### DETAILED DESCRIPTION OF THE PREFERRED EMBODIMENTS

In one suitable embodiment of the present invention, video feeds of one or more video cameras of a personal video recording system may be presented on a display. The audio feeds of one or more microphones of a personal video recording system may also be made audible on one or more speakers. Any suitable number of feeds may be simultaneously presented. As used herein, the term presenting may be defined as providing visual displays, audible sounds, data flows or any other suitable presentation of information to the user.

Feeds made available by one or more video cameras and by one or more microphones may be recorded on at least one storage device for later playback and editing. Such storage devices may be servers, web servers, remote servers, home servers (e.g., home media servers), digital video recorders (e.g., TiVo™, ReplayTV™), writeable DVDs, writeable CDs, hard disk drives, or any other suitable storage device. Audio and video information may be stored in any suitable format. Auxiliary devices external to the personal video recording system may interface with the personal video recording system using standard connection techniques (e.g., RCA jacks, Firewire, or any other suitable connection techniques) such that information from auxiliary devices may be transferred to the personal video recording system. Auxiliary devices may include hand-held video devices, digital cameras, and portable media such as floppy disks, VHS tapes, DVDs, CDs, cassette tapes, or any other suitable media. Auxiliary devices may also interface with the personal video recording system using any suitable wireless approach. In one suitable approach, information may be transferred to, and stored on, the auxiliary devices. For example, auxiliary devices such as wireless devices may interface with the personal video recording system using Bluetooth or any other suitable wireless connection technique (e.g., IEEE standard 802.11b).

The personal video recording system may also provide a user-friendly guidance application to facilitate the retrieval of stored footage. Footage may be stored by day, by time, by source (e.g., by camera, by external device), by name (e.g., by title), by category, or by any other suitable approach.

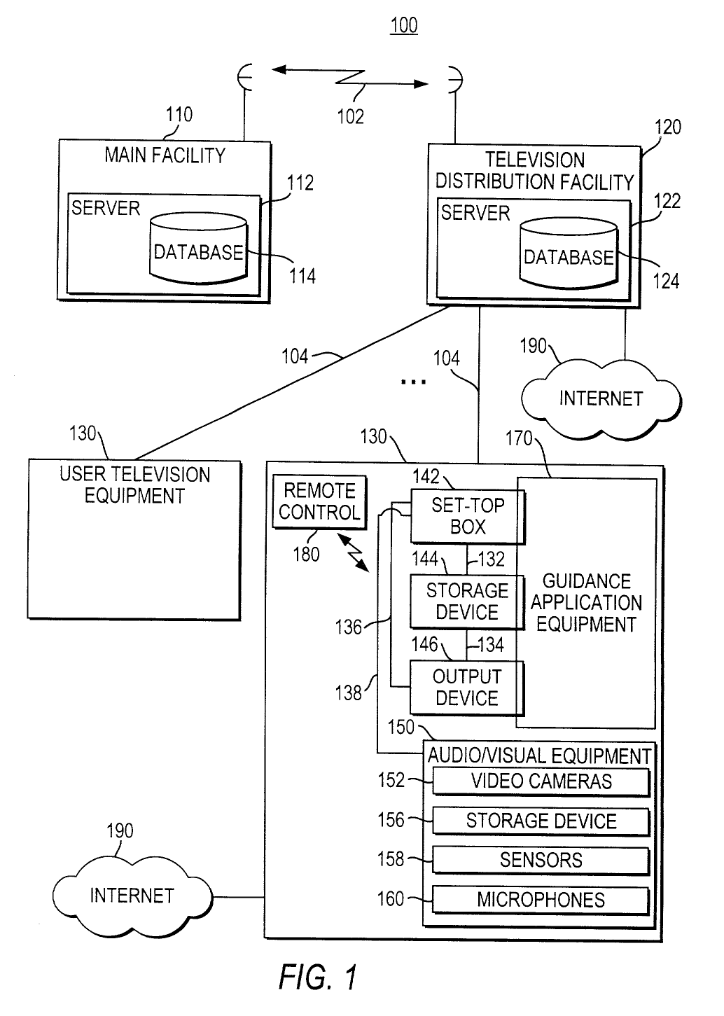

An illustrative personal video recording system 100 in accordance with the present invention is shown in FIG. 1. Illustrative personal video recording system 100 may include a main facility 110, a television distribution facility 120 and user television equipment 130. The personal video recording system may include the system shown in system 100, a guidance application, and any other suitable element that may be used to implement the present invention. Any suitable third party application may be part of system 100.

Main facility 110 may include a server 112. Server 112 may include a database 114 for storing any suitable information. Server 112 may be based on one or more computers. Information from server 112 and database 114 may be transmitted to television distribution facility 120 via communications link 102. Communications link 102 may be a satellite link, a telephone network link, an Internet link, a cable or fiber optic link, a microwave link, a combination of such links, or any other suitable communications link. If it is desired to transmit video signals in addition to data signals, a relatively high bandwidth link such as a satellite link may be preferable to a relatively low bandwidth link such as a telephone line.

Television distribution facility 120 may be a facility for distributing television signals to users, such as a cable system headend, a broadcast distribution facility, or a satellite television distribution facility. Television distribution facility 120 may include a server 122. Server 122 may include a database 124 for storing any suitable information. Server 122 may be based on one or more computers.

Regardless of its source, audio and video information may be maintained on server 122 or database 124 within television distribution facility 120, if desired. Server 122 and database 124 may be capable of handling text, images, graphics, video, any other suitable element, or a combination of these elements. In addition, server 122 and database 124 may be capable of providing interactive services such as near video on demand (NVOD) and video on demand (VOD). With such applications, videos that are stored on server 122 may be requested by users at user television equipment 130 or any other suitable equipment. The videos may then be played back to the users over communications paths 104.

Each component of user television equipment 130 may have a receiver such as set-top box 142 or any other suitable television or computer equipment into which circuitry similar to set-top box circuitry has been integrated. Any suitable multi-media device may be used to implement personal video recording system 100. Multi-media device may be any suitable television equipment having multi-media capabilities. The term multi-media device as used herein is not intended to include a personal computer. Multi-media devices may be for example, a set-top box, a personal video recorder (e.g., TiVo™ or ReplayTV™), a television having an integrated set-top box, a WebTV box, a personal computer television (PC/TV), a handheld computing device, or any other suitable equipment. For clarity, the present invention is described primarily in connection with user equipment based on a set-top box arrangement. This is merely illustrative.

Information from a set-top box 142 may be exchanged with a storage device 144 such as a server, a web server, a remote server, a home server (e.g., a home media server), a digital video recorder such as TiVo™ or ReplayTV™, a writeable DVD, a writeable CD, a videocassette recorder (VCR), or any other type of recording device so that footage may be stored. Information may be exchanged between set-top box 142 and storage device 144 via communications link 132. Communications link 132 may be any suitable link. When information is to be stored on a storage device not located in the user's home, information may be exchanged over link 104 or to Internet 90 over Internet paths.

Information from each storage device 144 may be transmitted to an output device 146 via communications link 134. Output device 146 may be a computer monitor, a television, or any other suitable video output device. Output device 146 may also have suitable audio output equipment such that audio information transferred to output device 146 may be audible. In one suitable embodiment of the present invention, storage devices 144 may be used normally when personal video recording system 100 of the present invention is not implemented. That is, VCRs, devices such as TiVo™ or ReplayTV™, or any other suitable devices may be used conventionally when personal video recording system 100 is not being used. Information from set-top box 142 may also be transferred directly to output device 146 via communications link 136.

Set-top box 142, storage device 144, and output device 146 may be controlled by remote control 180, a mouse, trackball, wireless keyboard, voice recognition system, touchpad, dedicated keys, or any other suitable user interface.

If desired, other types of user television equipment 130, such as those based on personal computer televisions (PC/TVS) or advanced television receivers may be used instead of a configuration based on a set-top box. However, for clarity the present invention will be described primarily in connection with a set-top box arrangement. Different configurations may be used for distributing information to user television equipment 130 such as configurations in which information may be distributed to user television equipment 130 without passing through television distribution facility 120 using paths (e.g. Internet paths or wireless paths) that are separate from communications paths 104. In other suitable embodiments, personal video recording system 100 may not include main facility 110, television distribution facility 120, or other facilities outside the user's home. For clarity, the present invention will be described primarily in connection with the illustrative information distribution arrangement shown in FIG. 1.

User television equipment 130 may also include audio/visual equipment 150. Audio/visual equipment 150 may include video cameras 152, storage device 156, sensors 158, microphones 160, and any other suitable device. Video cameras 152 and microphones 160 may be placed in any area of a user's home. Multiple video cameras 152 and multiple microphones 160 may also be placed in the same area of a user's home. Video cameras 152 and microphones 160 may acquire video and audio information. This video and audio information may be the video and audio information provided to the user of personal video recording system 100. This information may be in analog or digital form. Information acquired in analog form may be digitized prior to transmitting or storing. Video and audio information may be provided to the user of the personal video recording system 100 by any suitable video and audio capture devices. Video capture devices may include, for example, video cameras 150, auxiliary devices (e.g., hand-held video cameras, digital cameras), and any other suitable equipment that may provide video information.

Storage device 156 may store video and audio information acquired by video cameras 152, microphones 160, and by any other suitable source. Storage device 156 may be used to permanently store information, or storage device 156 may be used to temporarily store information. Information stored at storage device 156 may be transmitted to any other suitable storage device. For example, information may be transmitted to storage device 144, server 122, database 124, server 112, database 114, or any other suitable storage device. Information may be transmitted from storage device 156 periodically (e.g., once per hour, once per day) or upon request to any suitable element of personal video recording system 100. Information from audio/visual equipment 150 (e.g., storage device 156) may be transmitted to set-top box 142 via communications path 138.

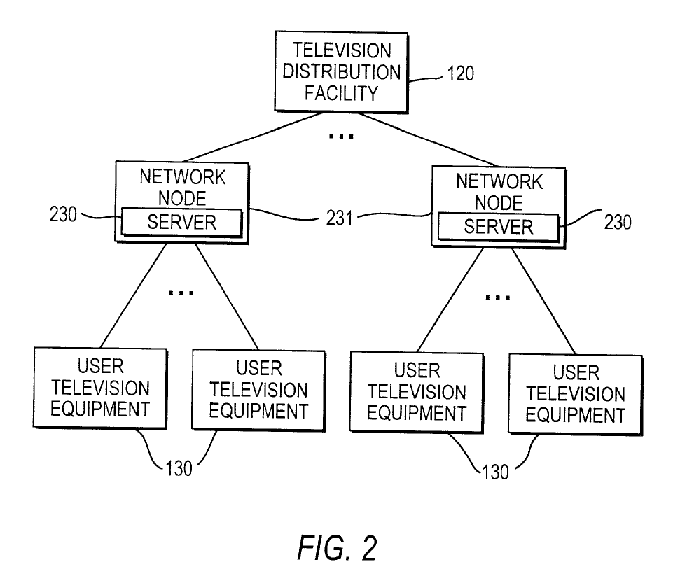

As shown in FIG. 2, the capabilities of server 122 may be provided using servers 230 located at network nodes 231. Servers such as servers 230 may be used instead of server 122 or may be used in conjunction with a server 122 located at television distribution facility 120. Similar approaches may be used for server 112 located at main facility 110 or for any other server or storage device.

In one suitable embodiment of the present invention, personal video recording system 100 may be used for surveillance. In such an embodiment, personal video recording system 100 may begin to acquire video or audio information when sensors such as sensors 158 are tripped. In one suitable approach, audio/visual equipment 150 may begin to acquire audio and video information when sensors 158 are tripped. Audio/visual equipment 150 may begin to acquire information when, for example, sensors 158 are tripped for a predetermined period of time (e.g., thirty seconds), or upon the first instance that a sensor 158 is tripped. Sensors 158 may include sensors such as motion sensors, audio sensors, light sensors, lights-on sensors, door or window open sensors, heat sensors (e.g., fire, body heat), smoke sensors, carbon monoxide sensors, and weight sensors. Audio/visual equipment 150 may send a signal (silent or non-silent alarm) to the police or to a home surveillance system when, for example, any one or more sensors 158 are tripped.

In another suitable embodiment, the surveillance may be time-based. Audio/visual equipment 150 may begin to acquire information starting at a pre-determined time. Audio/visual equipment 150 may stop acquiring information at another pre-determined time. For example, personal video recording system 100 may be used to monitor activity in a user's home when the user is not going to be home or sleeping. These examples are merely illustrative. Any suitable time-based surveillance may be used.

Personal video recording system 100 of the present invention may provide the user with a user-friendly guidance application. The guidance application may facilitate the retrieval of stored audio and video information. The guidance application may also provide for a user-friendly presentation of real-time video and audio information. The guidance application may be implemented using user television equipment 130 that is based on a personal computer, a WebTV box, a personal computer television (PC/TV), a handheld computing device, or any other suitable equipment.

The guidance application may be controlled by, for example, guidance application equipment 170. Guidance application equipment 170 may include processing circuitry for monitoring a user's requests of the guidance application and for the distribution of information. As shown, guidance application equipment 170 may include or be a part of set-top box 142, storage device 144 or any other suitable user television equipment or any suitable combination thereof. Guidance application equipment 170 may also be included in any other suitable location such as main facility 110, television distribution facility 120, or any other location not shown. Server 112, database 114, server 122, and database 116 may include any information to implement the guidance application. In another suitable approach, the guidance application may be implemented using a client-server architecture using guidance application equipment 170 as a client processor and a server such as storage device 144, server 112 or server 122.

In one suitable embodiment of the present invention, it may not be necessary for all of the components shown in user television equipment 130 to be present in a user's user television equipment 130 to implement personal video recording system 100. For example, for users with multiple homes, information may be transferred between homes using any suitable approach. The two geographically disparate systems may share information using, for example, a dial-up connection, via server 122, the Internet 190, or any other suitable communications link. A storage device (e.g., storage device 144) may be maintained at only one system. A second system may transmit video and audio information to the storage device at the first system using any suitable approach (e.g., via a wireless communications link, via Internet broadcast, via links 104 and server 122, or via any other suitable approach).

In another suitable embodiment, information may be transferred from one personal video recording system 100 to another personal video recording system 100 using any suitable approach (e.g., via a dial-up connection, via Internet 190, via a portable disk, or via any other suitable medium or communications approach). As shown in FIG. 1, user television equipment 130 may be provided with direct access to the Internet 190. User television equipment 130 may also be provided with access to the Internet 190 through television distribution facility 120.

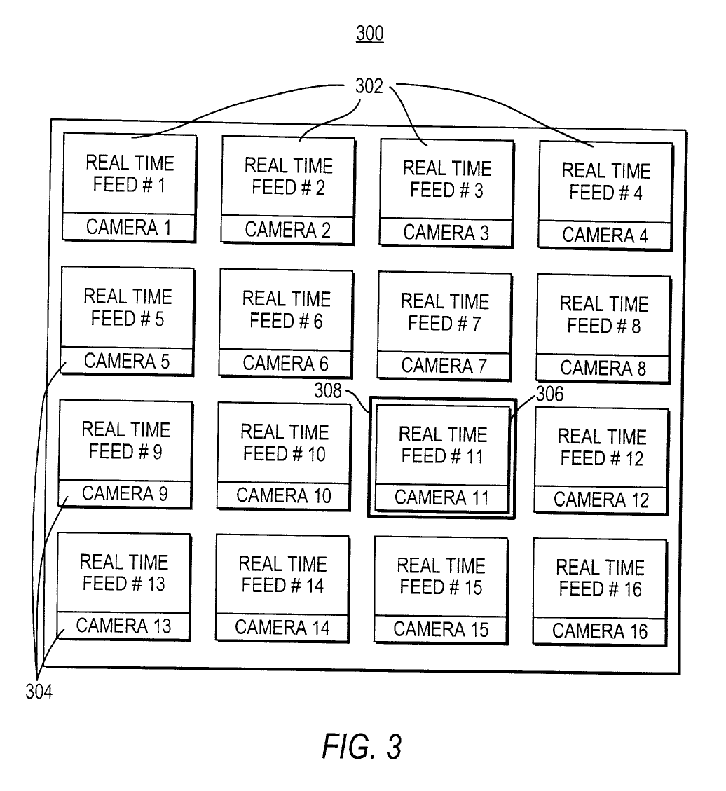

In one suitable embodiment of the present invention, personal video recording system 100 may display any suitable display screen on, for example, output device 146 in response to a user command. The user command may take the form of, for example, pressing a “video” key on remote control 180 (FIG. 1). A display screen such as display screen 300 of FIG. 3 may be generated that may display various feeds of real-time video, stored video, or both.

As shown in illustrative display screen 300, any number of real-time video feeds may be displayed on a display (e.g., output device 146) at any given time. Each individual feed may be displayed in an individual portion of the display screen. All video feeds of personal video recording system 100 need not be displayed simultaneously on an output device (e.g., output device 146). In one suitable approach, personal video recording system 100 may provide the user with the ability to have video feeds that are not currently displayed to be displayed on the output device. For example, personal video recording system 100 may display a video feed currently not displayed in a portion of a display screen in response to the user pressing the arrow keys on remote control 180.

The portions of the display screen, such as portions 302 may be any size or shape. For example, portions such as portions 302 may be in a 4:3 or 16:9 aspect ratio. Portions 302 may have a height/width ratio such that none of the video feed to be displayed in a portion 302 is cut off. That is, the height/width ratio of a portion may be the same as the height/width ratio of the video feed to be displayed in that portion.

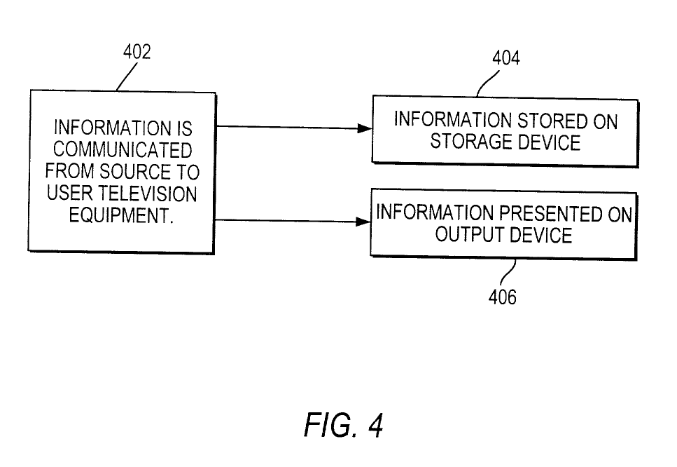

FIG. 4 shows a flow chart of illustrative steps involved in communicating information from a source to user television equipment, storing the information on a storage device, and presenting the information to the user. As shown in the illustrative flow chart of FIG. 4, information (e.g., from video and audio feeds) is communicated from a source to user television equipment. This may occur at step 402. This information may be stored on a storage device (e.g., storage device 144) at step 404. This information may also be presented to the user via an output device (e.g., output device 146) in real-time. This flow chart is merely illustrative. Any suitable approach to communicate information from a source to user television equipment, store the information on a storage device, and present the information to the user may be used.

Returning to FIG. 3, an overlay, such as overlay 304, may be displayed in, or in close proximity to, a portion such as portion 302. Overlays such as overlays 304 may display any information that is related to the particular video feed displayed in the portion with which overlay 304 is associated. For example, an overlay 304 may display information such as the name of the source providing the video feed. Any other suitable information, such as the current time, may also be displayed in an overlay such as overlay 304.

When an overlay such as overlay 304 is displayed in portion 302, the height/width ratio of portion 302 may be different than the height/width ratio of the ratio of the formatted feed. The ratio of portion 302 may be any suitable ratio to accommodate the presence of overlay 304. For example, when overlay 304 is displayed over portion 302, the height/width ratio of portion 302 may be such that the video feed displayed in portion 302 will not be cut off although overlay 304 is simultaneously displayed in portion 302.

As shown in FIG. 3, personal video recording system 100 may provide the user with the ability to navigate to portions 302 of a display screen. In the embodiment shown in illustrative display screen 300 of FIG. 3, an indicator such as a highlight ring 308 may be displayed around or in close proximity to portions 302. When an indicator is displayed around or in close proximity to a portion, special features associated with that portion may be accessed or automatically initiated. As shown in FIG. 3, for example, highlight ring 308 is displayed around portion 306—the portion associated with camera 11. In one suitable approach, when an indicator such as highlight ring 308 is displayed around or in close proximity to a portion, the audio feed for the source associated with that portion may become audible. When an indicator such as highlight ring 308 is not displayed around or in close proximity to a portion, the audio feed for the video camera associated with that portion may not be audible.

In another suitable embodiment, the audio feed associated with a source may be inaudible until personal video recording system 100 is commanded to make an audio feed audible. An example of a suitable command may be, for example, the user pressing an “audio” key on remote control 180.

Another example of a special feature that may be initiated when an indicator such highlight ring 308 is displayed around or in close proximity to a portion is displaying the video feed displayed in that portion in full screen. Personal video recording system 100 may provide the user with the ability to display the video feed from a source in response to any suitable user command. Such a suitable user command may be, for example, pressing the “enter” key on remote control 180.

Other special features that may also be initiated in response to the user pressing the “enter” key may be, for example, providing options to the user to set particular feeds as favorites, providing parental control or other suitable lock-out features, and providing the user with the ability to edit and play back stored video feeds. These examples are merely illustrative. Any other suitable special feature may be initiated.

A highlight or indicator such as highlight ring 308 may be navigated among portions or any other suitable element of a display screen. Personal video recording system 100 may allow a user to move a highlight or indicator by issuing any suitable command. Such a suitable command may be, for example, pressing the arrow keys on remote control 180. With a set-top box arrangement, for example, the user may use a remote control or wireless keyboard to navigate among the various portions and other elements of a display screen. With a personal computer, the user may use a keyboard, mouse, trackball, touch pad, or any other suitable input or pointing device. Users may also interact with personal video recording system 100 using an interactive voice response system (e.g., a system that responds to verbal commands). This feature is explored in more detail in “User Speech Interfaces for Interactive Media Guidance Applications,” U.S. patent application No. ______ (Reichardt et al.), filed on even date, which is hereby incorporated by reference herein in its entirety. The interactive voice response system may be located at main facility 110, television distribution facility 120, user television equipment 130, or any other suitable source.

These examples are merely illustrative. Any other suitable option or command may be provided by personal video recording system 100. The display screen presented by personal video recording system 100 is also merely illustrative. Any other suitable arrangement may be used.

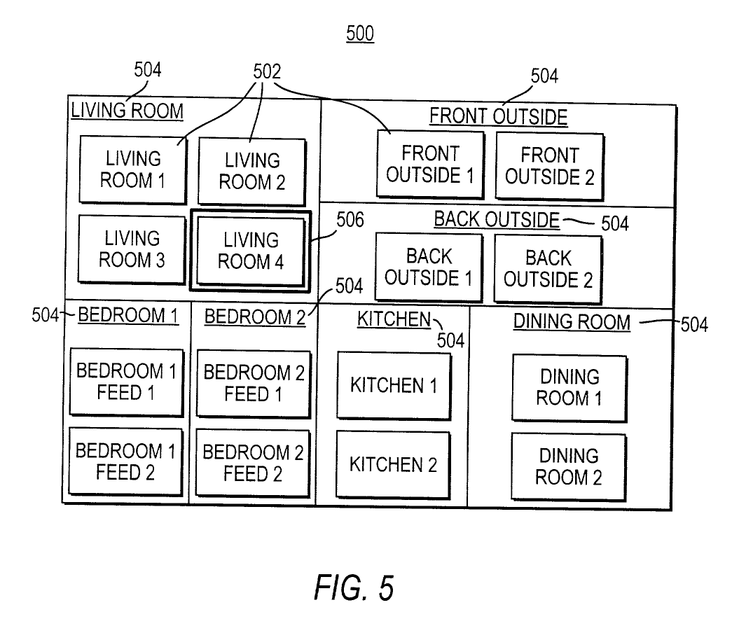

For example, personal video recording system 100 may display a display screen such as illustrative display screen 500 of FIG. 5. As shown, the video feeds displayed in portions 502 may be organized in any suitable way. For example, the video feeds for particular rooms of a home, or areas outside of a home, may be arranged in groups. An arrangement such as this may facilitate determining which video feeds are displayed in which portions.

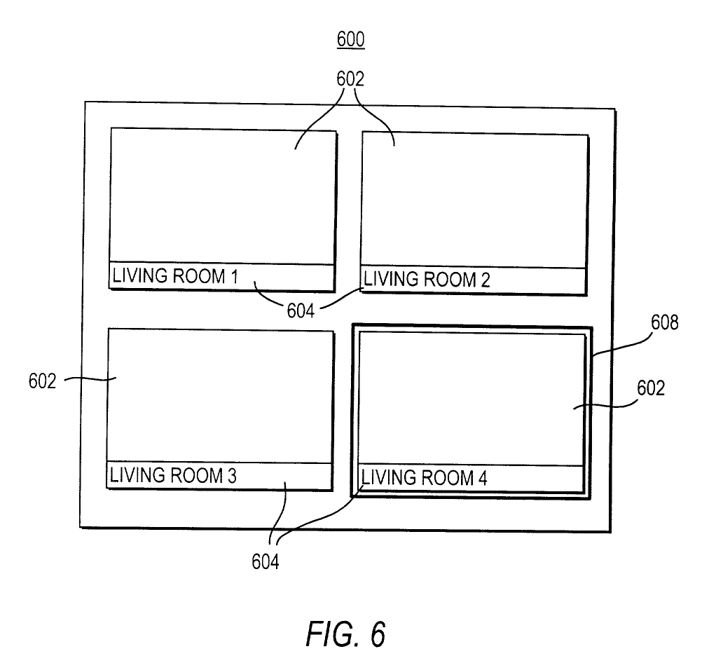

Selectable options such as selectable options 504 may be displayed when there is more than one video feed for a particular area of a home (indoors or outdoors). Selecting a selectable option such as selectable option 504 may take the user to a display screen such as display screen 600 of FIG. 6. A display screen such as display screen 600 may provide the user with multiple views of an area of a user's home simultaneously.

As shown in display screen 600, the video feeds for the same area (e.g., same room or area outside of a home) may be displayed simultaneously. Each individual feed may be displayed in an individual portion such as portions 602. Overlays such as overlays 604 may be displayed in, or in close proximity to, portions 602. Overlays 604 may display any pertinent information for the source with which overlay 604 is associated. This information may be, for example, the name of the source from which the video feed is provided (e.g., living room 4).

When there are multiple video feeds for the same area of a home, audio feeds associated with the multiple video feeds may automatically be audible or may become audible in response to, for example, the user pressing an “audio” key on remote control 180. In one suitable approach, there may be a highlight ring or indicator such as highlight ring 608 displayed around, or in close proximity to, a portion. Audio information for the portion that has a highlight ring or indicator displayed around it may be audible. In another suitable approach, the audio information for all of the video feeds may be audible. In this approach, the audio information associated with the video feeds may be presented to the user in any suitable way. For example, the audio feeds may be presented to the user in surround sound such that it sounds like the user is in the middle of the room or area from which the video feeds are taken. The audio information may be decoded at any suitable device such that the audio information may be presented in, for example, surround sound.

Display screen 500 is merely illustrative. Any suitable options may be used in addition to or in place of options 504. For example, when there are multiple video feeds for an area (as shown in illustrative display screen 500 of FIG. 5), the guidance application may provide the user with options in addition to or in place of selectable options 504 to display the multiple video feeds.

In another suitable approach, the guidance application may allow the user to display the multiple video feeds for an area by pressing an “angle” key (i.e., camera angle) or “mode” key on remote control 180. When the user navigates to a portion for a video feed for a particular area and the user presses the “angle” key or “mode” key, a menu screen with the video feeds for that area may be displayed.

For example, if the user navigates to portion 506 of illustrative display screen 500, and the user presses the “angle” key or “mode” key on remote control 180, a display screen such as illustrative display screen 600 may be displayed. As shown in FIG. 5, the portion to which the user had navigated (i.e., portion 506) is associated with the video feed for a living room. Upon pressing the “angle” key or “mode” key, the video feeds for the living room may be displayed as described above.

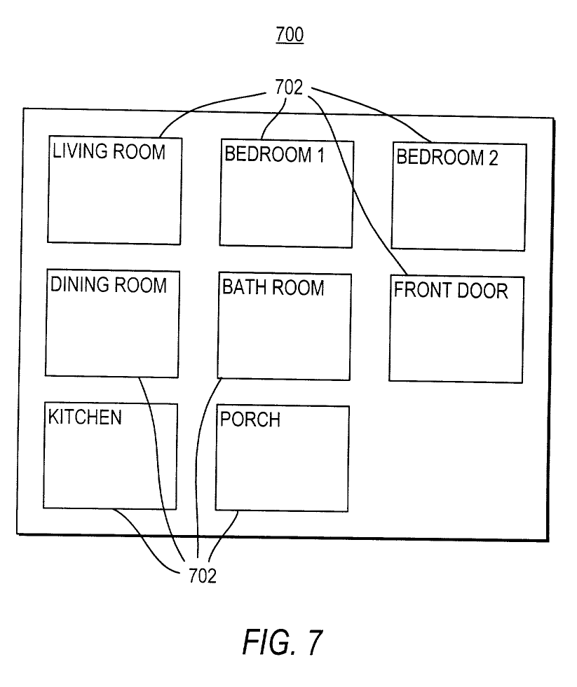

In another suitable approach, personal video recording system 100 may generate a display screen similar to display screen 600 when, for example, a portion for a particular area of a user's home has been navigated to and the user presses a “select” key or “enter” key on remote control 180. In illustrative display screen 700 of FIG. 7, for example, there may be multiple portions corresponding to multiple areas of a user's home. As shown in illustrative menu screen 700, portions 702 may be associated with areas of the user's home. Personal video recording system 100 may allow the user to navigate among portions 702 by, for example, pressing the arrow keys on remote control 180. Upon navigating to a particular portion 702, personal video recording system 100 may provide the user with the ability to have the information for the area associated with that portion presented to the user. When there is only one video feed for the area associated with the portion to which the user has navigated, and the user presses an “enter” key on remote control 180, the video feed for that area may be displayed in full screen. When there is more than one video feed for the area associated with that portion, and the user presses an “enter” key, then a display screen such as display screen 600 of FIG. 6 may be displayed. These examples are merely illustrative. Any suitable way for presenting information to the user may be used.

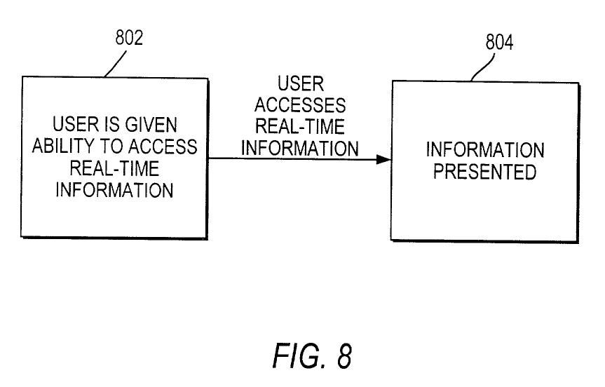

An illustrative flow chart for presenting real-time information is shown in FIG. 8. As shown, the user may be given the ability to access real-time information (e.g., real-time video and audio information from audio/visual equipment 150). This may occur at step 802. When the user accesses real-time information, the real-time information may be presented (e.g., on output device 146). This may occur at step 804. This flow chart is merely illustrative. Any suitable approach to access real-time information and present real-time information may be used.

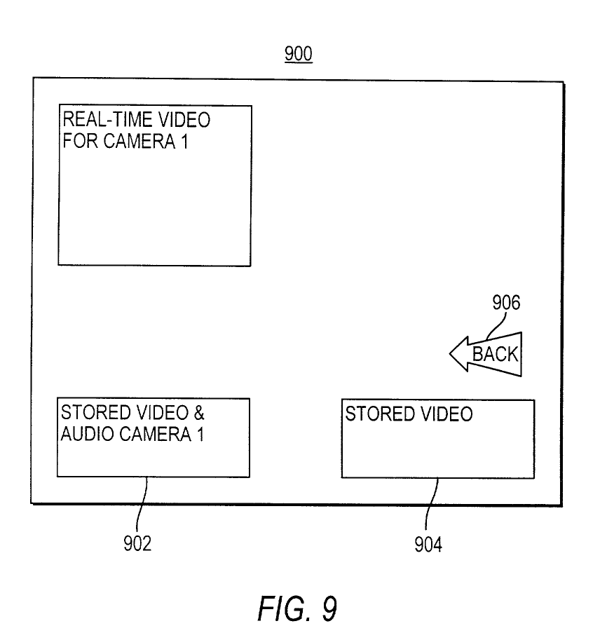

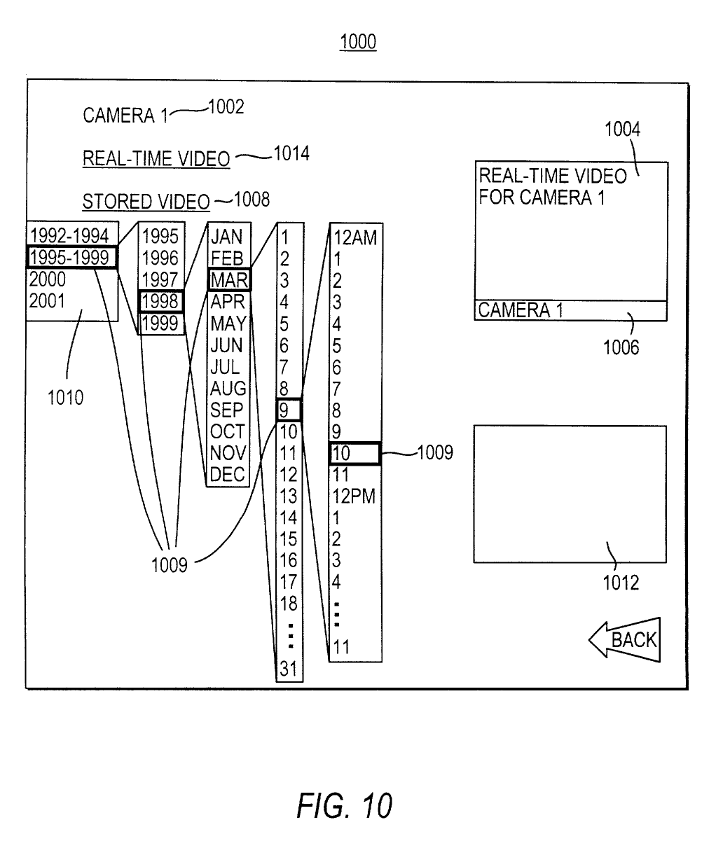

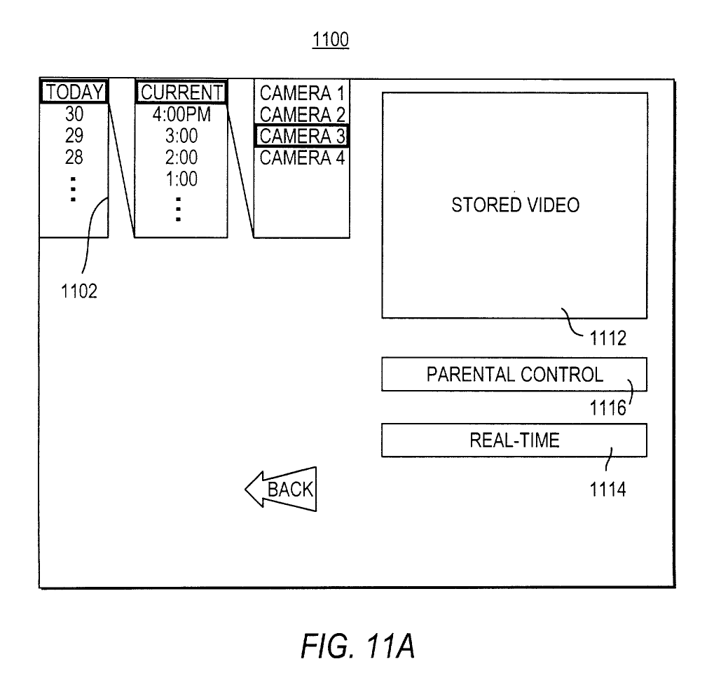

Any suitable approach to access stored video and audio information, and present stored video and audio information may also be used. As shown in illustrative display screen 900 of FIG. 9, a link to stored video and audio 902 for the stored video and audio of a particular source may be displayed simultaneously with the real-time video of that particular feed (the real-time audio information may or may not be audible). Upon selecting a link to stored video and audio such as link 902, personal video recording system 100 of the present invention may generate a display screen such as display screen 1000 of FIG. 10. A link to general stored video and audio may also be provided in a display screen such as display screen 900. For example, upon selection of link to stored video and audio 904, a display screen such as illustrative display screen 1100 of FIG. 11A may be displayed. In another suitable approach, personal video recording system 100 may allow the user to have stored video and audio footage (for particular video and audio feeds or general stored video and audio) presented by, for example, pressing the “stored” key on remote control 180. As shown in FIG. 9, a link may be provided such that the user may be able to return to the display screen that was displayed prior to the currently displayed display screen. Such a link may be “back” link 906. This example is merely illustrative. Any suitable way to return to the previously displayed display screen may be used. A link to return to the display screen that was displayed prior to the currently displayed display screen may be provided on any display screen.

In illustrative menu screen 1000 of FIG. 10, personal video recording system 100 may allow the user to access stored video and audio for a particular video and audio feed. The name of the particular video feed may be displayed as name 1002. As the user navigates stored information for a particular source, the real-time information for that source may be presented in portion 1004. For example, when the user navigates among stored video for a particular video feed, the real-time video for that video feed may be displayed in portion 1004. An overlay such as overlay 1006 may also be displayed. A link to general stored video and audio 1008 may also be provided. Upon selection of link to stored video and audio 1008, a display screen such as illustrative display screen 1100 of FIG. 11A may be displayed. A link to real-time video 1014 may also be provided. Upon selection of link to real-time video 1014, any suitable display screen that displays real-time video (e.g., display screen 300 of FIG. 3) or provides links or opportunities to have real-time video displayed (e.g., display screen 500 of FIG. 5) may be displayed.

Personal video recording system 100 may allow a user to have stored video displayed on, for example, output device 146 such that the user may view the stored video. Stored video may be organized in any suitable way such that the user may be able to browse among stored video to determine where the user would like to begin viewing the stored video. As shown in FIG. 10, stored video may be organized hierarchically as items. Items may be organized in any other suitable way. For example, items may be organized using any suitable display structure, such as a grid, a listing, a menu, or any other suitable display structure. Items may be in the form of listings, icons, images, events (e.g., a sensor being tripped), time (e.g., 12:00 A.M.), equipment (e.g., camera 1, camera 2), or any other suitable form. Items may be displayed in any suitable arrangement. For example, items may be arranged by time. Items may be used to show where information is stored.

The user may navigate among the items of a hierarchical organization tree such as hierarchical organization tree 1010 of FIG. 10 by, for example, pressing the arrow keys on remote control 180. As shown in FIG. 10, the user may navigate among hierarchical organization tree 1010 to determine where the user would like to begin viewing stored information. Although hierarchical organization tree 1010 is shown with the largest directories as individual years and groups of years, tree 1010 may be organized in any suitable way. For example, tree 1010 may be organized by day, time, month, etc. The guidance application may indicate to the user through which branch or branches of the hierarchical tree (directory) the user has navigated by, for example, providing indicators around, or in the proximity of, the branches. For example, highlights 1009 may be used as such indicators. This example is merely illustrative. The guidance application may indicate to the user through which branches the user has navigated in any suitable way.

As the user navigates among a hierarchical organization tree such as hierarchical organization tree 1010, the first frame or first several frames of the stored video of the item to which the user has navigated may be displayed in a portion such as portion 1012. In another suitable embodiment, personal video recording system 100 may start displaying the entire stored video starting at the item to which the user has navigated. For example, if the user navigated to an item for the month of February, 1998, the first frame, or the first several frames of the stored video starting at 12:00 A.M., Feb. 1, 1998 may be displayed. In another suitable embodiment, the entire stored video may be displayed. Personal video recording system 100 may provide the user with the ability to view the stored video of the item to which the user has navigated by pressing the “enter” key on remote control 180 or by issuing any other suitable command. In response to a suitable command, personal video recording system 100 may display the selected stored video in portion 1012 or in full screen.

A portion such as portion 1012 may be displayed concurrently with portion 1004. If desired, a portion such as portion 1012 may be displayed without portion 1004.

Personal video recording system 100 may allow the user to navigate among stored video for a particular video feed in any suitable way. The navigation of stored video described in connection with illustrative display screen 1000 of FIG. 10 is merely illustrative. Any other suitable way to retrieve and display stored video may be used. For example, the user may enter a date and time directly using keys on a remote control (e.g., remote control 180) or keyboard.

Upon selection of link to stored video 904 or link to stored video 1008, a display screen such as illustrative display screen 1100 of FIG. 11A may be displayed. As shown in illustrative menu screen 1100 of FIG. 11A, the user may navigate among the items of a hierarchical organization tree such as hierarchical organization tree 1102 by, for example, pressing the arrow keys on remote control 180. Although hierarchical organization tree 1102 is shown with the largest directories as video sources (e.g., camera 1, camera 2, etc.) hierarchical organization tree 1102 may be organized in any suitable way. For example, hierarchical organization tree 1102 may be arranged by year. As shown in FIG. 11A, the user may navigate among hierarchical organization tree 1102 to determine where the user would like to begin viewing stored information.

As the user navigates among hierarchical organization tree 1102, the first frame or first several frames of the stored video of the item to which the user has navigated may be displayed in portion 1112. In another suitable embodiment, personal video recording system 100 may start displaying the entire stored video starting at the item to which the user has navigated. For example, if the user navigates to a item for camera 1, the month of February, 1998, the first frame, or the first several frames of the stored video and associated audio for camera 1 starting at 12:00 A.M., Feb. 1, 1998 may be displayed in portion 1112. In another suitable embodiment, the entire stored video may be displayed in portion 1112. In these embodiments, the associated audio information may also be audible.

Personal video recording system 100 may provide the user with the ability to view and hear the stored video and audio of the item to which the user has navigated by pressing the “enter” key on remote control 180 or by issuing any other suitable command. In response to a suitable command, personal video recording system 100 may display the selected stored video in portion 1112 or in full screen. If desired, audio information that was previously inaudible may also become audible.

In embodiments in which any user (e.g., a child) may be able to access any stored video and audio information, it may be desirable to lock certain stored video and audio information. Personal video recording system 100 may provide a user (e.g., a parent) with suitable parental controls or lock-out features when, for example, the user selects a link to parental control features such as parental control link 1116. Upon selection of parental control link 1116, the user may be provided with the ability to lock certain stored video and audio information (e.g., by date, by time, by camera, or any combination thereof). When certain stored video and audio information is locked, that information may not be accessed without, for example, a password or some other sort of verification. In circumstances where stored video and audio information is password protected, the first frame nor the first several frames of the stored video may not be displayed, for example, in portion 1112. The stored video may also not be displayed, for example, in portion 1112. The associated audio may also not be audible.

In response to the user navigating to locked (e.g., password protected) stored video and audio information, an authorization request may be generated by personal video recording system 100. As shown in FIG. 11B, the authorization request may be displayed in, for example, authorization request portion 1120. Authorization request portion 1120 may be displayed on any suitable portion of a display screen. For example, authorization request portion 1120 may be displayed over portion 1112 or a portion of portion 1112. The user may enter, for example, a password or any other suitable verification to access the locked stored video and audio information. The user may enter a password or any other suitable verification using, for example, remote control 180, a mouse, trackball, wireless keyboard, voice recognition system, touchpad, dedicated keys or any other suitable user interface device. Upon proper authorization, personal video recording system 100 may display the unlocked stored video in full screen or in portion 1112. The associated audio information may also become audible (if the audio information were previously inaudible). The previously locked video may automatically become locked when the user has finished watching and listening to the stored video and audio, may become locked when the user has finished using personal video recording system 100, or remain unlocked until it is actively locked by the user.

Although parental control link 1116 is shown in FIG. 11A, any suitable parental control link or feature may be provided on any display screen or by issuing any suitable command. These examples are merely illustrative. Any suitable approach to lock out certain information and unlock certain information may be provided.

Personal video recording system 100 may allow the user to navigate among stored video and audio for particular video and audio feeds in any suitable way. The navigation of stored video and audio information described in connection to illustrative display screens 1100, and FIGS. 11A and 11B is merely illustrative. Any suitable way to access and display stored video may be used.

As shown in FIG. 11A, a link to real-time video 1114 may also be provided. Upon selection of link to real-time video 1114, any suitable display screen that displays real-time video (e.g., display screen 300 of FIG. 3) or provides links or opportunities to have real-time video displayed (e.g., display screen 500 of FIG. 5) may be displayed.

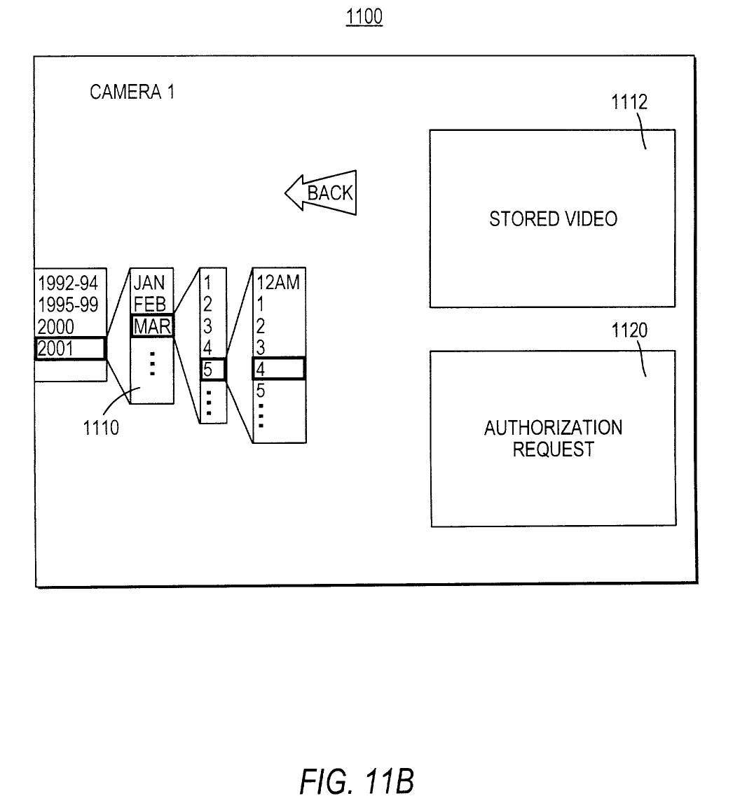

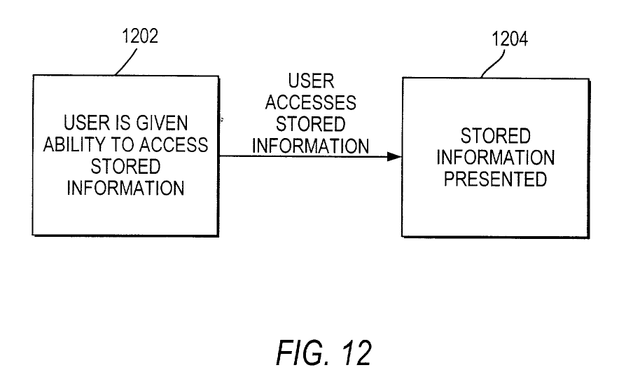

An illustrative flow chart for accessing and presenting stored video and audio information is shown in FIG. 12. As shown, the user may be given the ability to access stored video and audio information. This may occur at step 1202. When the user accesses stored video and audio information, the stored video and audio information may be presented on any suitable output device such as output device 146. This may occur at step 1204. This flow chart is merely illustrative. Any suitable approach to access stored video and audio information, and present stored video and audio information may be used.

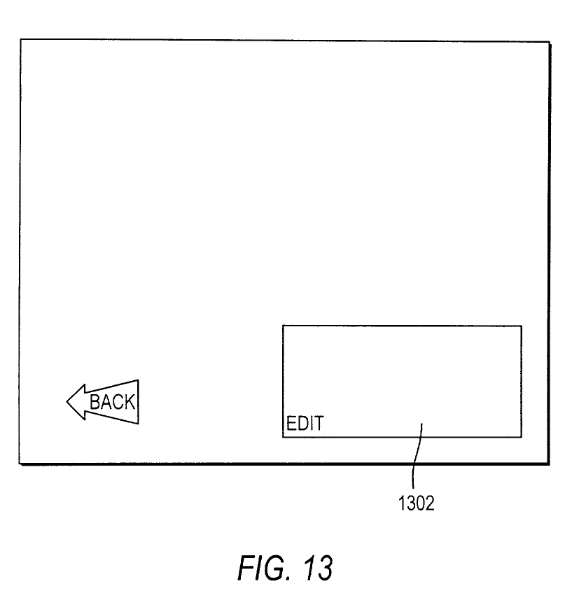

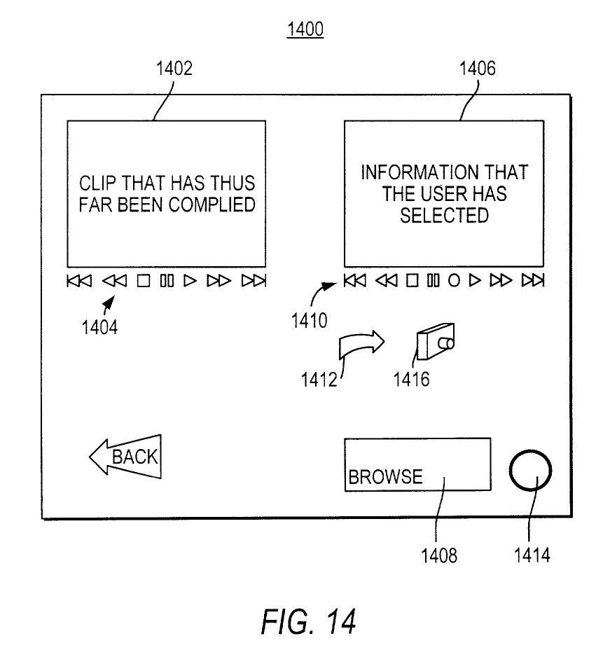

Personal video recording system 100 may provide options for the user to edit video and audio information. Such options may be accessed by, for example, selecting an edit link such as edit link 1302 of FIG. 13, or by pressing an “edit” key on remote control 180. Editing functionality may be provided by personal video recording system 100 or any suitable third party application. Any suitable third party application may also be used in conjunction with personal video recording system 100 of the present invention to provide editing functionality. The third party application may be resident on set-top box 142, storage device 144, guidance application equipment 170, sever 122, any other suitable component of personal video recording system 100, or any combination of such components. An edit link such as edit link 1302 may be provided in any suitable display screen. Upon selecting edit link 1302, personal video recording system 100 may generate a display screen such as display screen 1400 of FIG. 14.

As shown in illustrative display screen 1400 of FIG. 14, personal video recording system 100 may provide the user with suitable options to splice clips of audio and video information together. A portion, such as portion 1402, may display the clip that has thus far been compiled. When a user is compiling a clip, the first frame or the last frame of the clip may be displayed in portion 1402. In another suitable embodiment, the entire clip may be displayed. Navigation tools such as navigation tools 1404 may be provided such that a user may rewind to the beginning, rewind, stop playing, begin playing, pause, fast forward, and skip to the end of, the thus far compiled clip.

When a user is compiling a clip, the information for that clip may be stored on a temporary basis. This information may be stored at storage device 144 or at any other suitable location.

At any suitable point on the thus far compiled clip, the user may add more audio and video information to the clip. The user may be provided with the ability to navigate among stored audio and video information when compiling a clip. The user may be provided with the ability to navigate among stored audio and video information by, for example, selecting any suitable link such as browse link 1408. Upon selecting browse link 1408, the user may be provided with opportunities to navigate among and select real-time and stored video and audio information that the user would like to add to the thus far compiled clip. Upon selecting a link such as browse link 1408, personal video recording system 100 may take the user to a top-level directory (i.e., at the top of a hierarchically organized tree). Any suitable portion such as the real-time or first frame of the real-time or stored audio and video information that the user has selected to add to the thus far compiled clip may be displayed in a portion such as portion 1406.

Where applicable, the user may be provided with opportunities to cue the video and audio information. The audio and video information may be cued to the point that the user would like to add the information to the thus far compiled clip. The user may cue the audio and video information using, for example, navigation tools 1410. Navigation tools 1410 may be provided such that a user may rewind to the beginning, rewind, stop, begin playing, pause, fast forward, and skip to the end of, audio and video information. These tools, and sequences of selecting these tools, may also be used to play information at variable speeds in either direction. For example, if the user pressed the pause tool, and then pressed the rewind tool, individual frames of the video information may be played in reverse. Navigation tools 1410 may also be provided such that a user may add information to the thus far compiled clip.

When the user has cued the information to a suitable point, the user may add the information on to the thus far compiled clip by, for example, selecting the record navigation tool. Personal video recording system 100 may indicate to the user that a part of the thus far compiled clip will be recorded over when, for example, the last frame of the thus far compiled clip is not displayed in portion 1402 (i.e., when information is about to be added to a point other than the end of the thus far compiled clip). The user may decide whether or not to record over any information.

Personal video recording system 100 may also provide the user with the ability to insert information into a compiled clip without recording over any other information. For example, when the user cues the thus far compiled clip to a desired spot, the user may insert stored information into the thus far compiled clip.

In another suitable embodiment, audio and video information to be added to the thus far compiled clip may be automatically added to the end of the clip. When the user decides to stop adding audio and video information to the thus far compiled clip, the user may select the stop navigation tool. The user may then stop adding audio and video information to the thus far compiled clip entirely, or may browse for more information to add to the clip. When the user decides to stop adding information to the thus far compiled clip entirely, the user may select the stop recording navigation tool. When the user decides to browse for more information to add to the thus far compiled clip, the user may select browse link 1408 as described above, or in another suitable approach, select return navigation tool 1412. When the user selects return navigation tool 1412, the item for audio and information that is navigated to may be the item that was last navigated (e.g., the item for the information that was just added to the thus far compiled clip).

Personal video recording system 100 may also provide the user with opportunities to delete information from a compiled clip.

A compiling indicator such as indicator 1414 may be displayed to indicate to the user that the user is currently compiling a clip. Indicator 1414 may be displayed on any suitable display screen and at any suitable time to indicate to the user that personal video recording system 100 or a third party application is currently providing editing opportunities. Indicator 1414 may be any shape, color or size and may flash (i.e., be blinking) as appropriate.

Other than selecting stored audio and video information to be added to a clip such as the thus far compiled clip, personal video recording system 100 may provide the user with the ability to take still shots of stored video information. When, for example, video information is displayed in portion 1406, the user may take a still shot of the video by, for example, selecting still shot icon 1416. Selecting still shot 1416 will take a still shot of the frame of video displayed at the moment still shot icon 1416 was selected. For ease of use, the user may select still shot icon 1416 when the video displayed in portion 1406 is paused. Video displayed in portion 1406 may be paused by, for example, selecting the pause navigation tool. Personal video recording system 100 or any suitable third party application may provide the user with the ability to take a still shot of video information by, for example, pressing a “still shot” key on remote control 180. These examples are merely illustrative. Any suitable way to take still shots of video may be used.

Personal video recording system 100 or any suitable third party application may provide the user with the ability to compile still shots into a “slide show.” Each frame in the slide show may be displayed for a specified period of time. The duration that each slide is presented may be different for each slide.

Personal video recording system 100 or any suitable third party application may also provide the user with the ability to combine a still shot or still shots with video. When a still shot is combined with video, the still shot may be displayed for a specified duration of time when the compiled clip is played back.

While compiling a clip, personal video recording system 100 may also provide the user with the ability to enter identifiers into the clip. These identifiers may be used to identify specific frames, sequences of frames, or any other suitable element to be identified. During playback, these identifiers may be overlaid onto the video/frame on playback

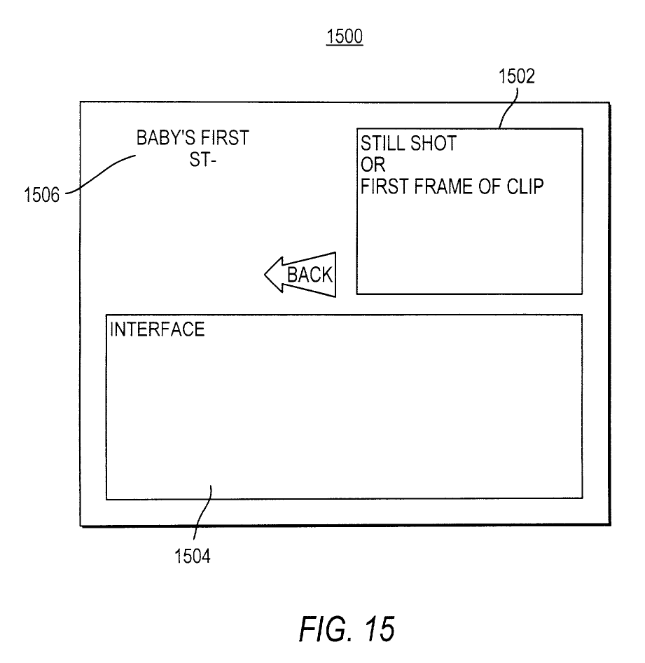

When the user has finished compiling a clip or taking a still shot or multiple still shots, personal video recording system 100 or suitable third party application may provide the user with an ability to name or otherwise identify the clip, still shot or still shots. The user may also be provided with the ability to name identifiers. As shown in illustrative display screen 1500 of FIG. 15, personal video recording system 100 may provide the user with the ability to name or otherwise identify any information (e.g., compiled clips, still shots, identifiers) as well as sources of information (e.g., video camera feeds) as desired. As shown in FIG. 15, the information or source of information to be named may be displayed in portion 1502. The information or source of information displayed in portion 1502 may be the first frame or first several frames of a compiled clip a still shot, an entire compiled clip, or the feed of a source (e.g., video camera) to be named or identified.

An interface such as interface 1504 may be provided such that the user may name or otherwise identify information. Interface 1504 may provide the user with the ability to select all of the letters of the alphabet (lowercase and capital), numbers, all punctuation, any other suitable element (e.g., a graphic or clip art). Interface 1504 may also provide the user with the ability to select pre-determined generic titles such as “Happy Birthday.” Interface 1504 may also have a backspace function and a clear function to edit the name accordingly. As the user begins naming the information, those characters thus far selected may appear on display screen 1500. As shown, the name thus far spelled out may appear as name 1506. Interface 1504 may also have a “finish” or a “done” function. The user may select the “finish” or “done” function to indicate to personal video recording system 100 or suitable third party application that the user has finished naming or otherwise identifying the information.

In response to the user indicating that the user has finished naming information to be stored, the user may be provided with the ability to store the information in any suitable location. The user may be provided with opportunities to store information on any storage device (remote or local) under any name. For example, the user may select to “browse” items for a suitable location to store information.

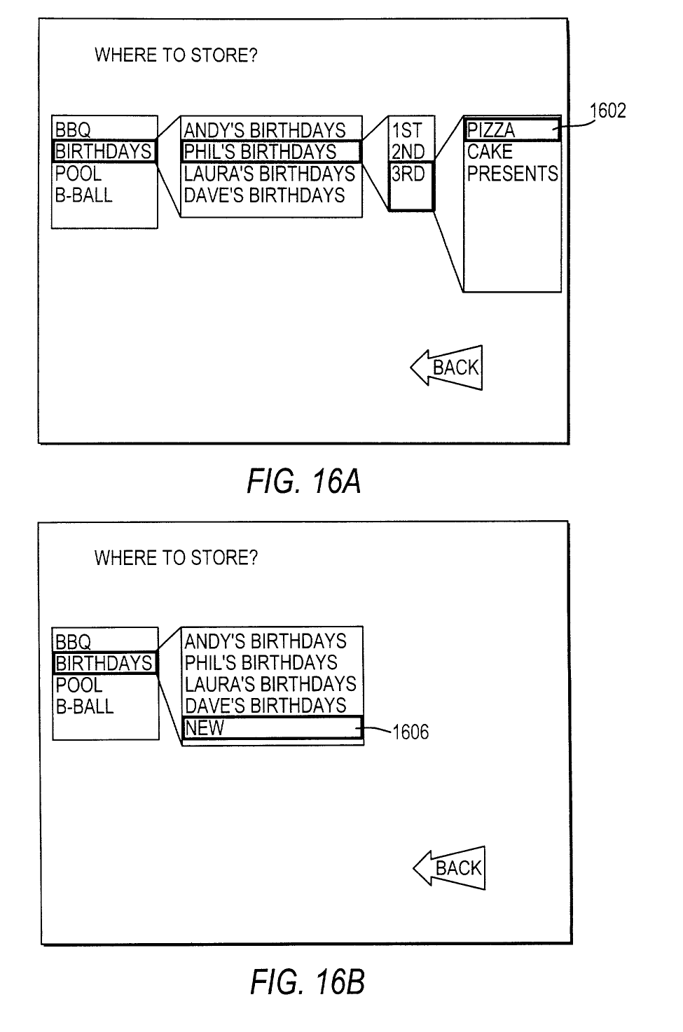

In another suitable approach, a display screen such as display screen 1600 of FIG. 16A may be displayed in response to a user indication that the user has finished naming the information to be stored. As shown in FIG. 16A, the user may be able to navigate among a hierarchically organized tree of stored information. Such a hierarchically organized tree of stored information may be tree 1602. When the user navigates to a location on tree 1602 where the user would like to have information stored, personal video recording system 100 may store the information there. Such an indication may be, for example, pressing a “store” key on remote control 180. Information may automatically be stored in the format in which it was recorded (e.g., video, still shots).

In the circumstance that the user can not find a suitable location on a tree such as tree 1602, the user may indicate to personal video recording system 100 to create a new directory or subdirectory on the tree. As shown in FIG. 16B, the user may select an empty item such as item 1606. That is, upon selection of an item with no information associated with it, or an item with no subdirectories which depend from it, personal video recording system 100 may provide the user with the ability to create a subdirectory or a new item. The user may also indicate to personal video recording system 100 to create a new directory, subdirectory or item by, for example, pressing a “create” key or a “new” key on remote control 180. In response to an indication that a new directory, subdirectory or item is to be created, a display screen with an interface such as display 1500 of FIG. 15 may be provided such that the user may be able to name the new directory, subdirectory or item.

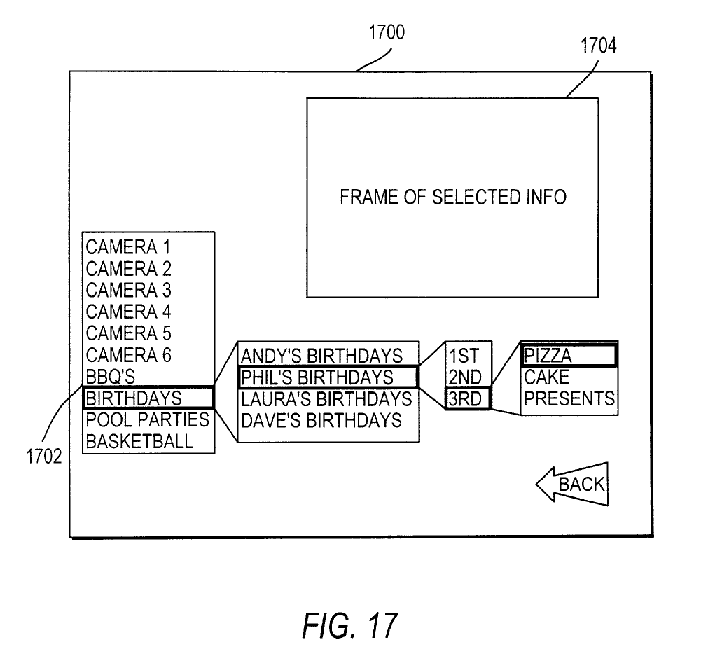

The user may access stored information for playback on, for example, output device 146. The user may access stored information by, for example, selecting a link to access stored information. User compiled clips and still shots may be incorporated into any suitable hierarchical trees such as trees 1010 and 1102 of FIGS. 10 and 11A, respectively. As shown in illustrative display screen 1700 of FIG. 17, for example, hierarchically organized tree 1702 may provide access to stored information including information from video and audio feeds, compiled clips, still shots, and any other suitable information.

When the user navigates to an item for stored information on hierarchical organization tree 1702, the first frame or first several frames of the stored video of the item to which the user has navigated may be displayed in a portion such as portion 1704. In another suitable embodiment, personal video recording system 100 may start displaying the entire stored video starting at the item to which the user has navigated. When the user navigates to an item for a source of information on hierarchical organization tree 1702, the real-time information for that source may be displayed in portion 1704. The user may also be provided with the ability to select stored information for a source via hierarchical organization tree 1702.

When the user has selected a video, personal video recording system 100 may provide the user with the ability to navigate between scenes. For example, personal video recording system 100 may provide the user with the ability to skip to the next or previous scene, or restart the current scene. Scenes may be individual segments that were spliced into a compiled clip during editing, or may otherwise be identified by the user during editing. For example, the user may specify that a scene is the sequence of frames between two identifiers. These examples are merely illustrative. Any suitable approach to navigate between scenes and identify scenes may be used.

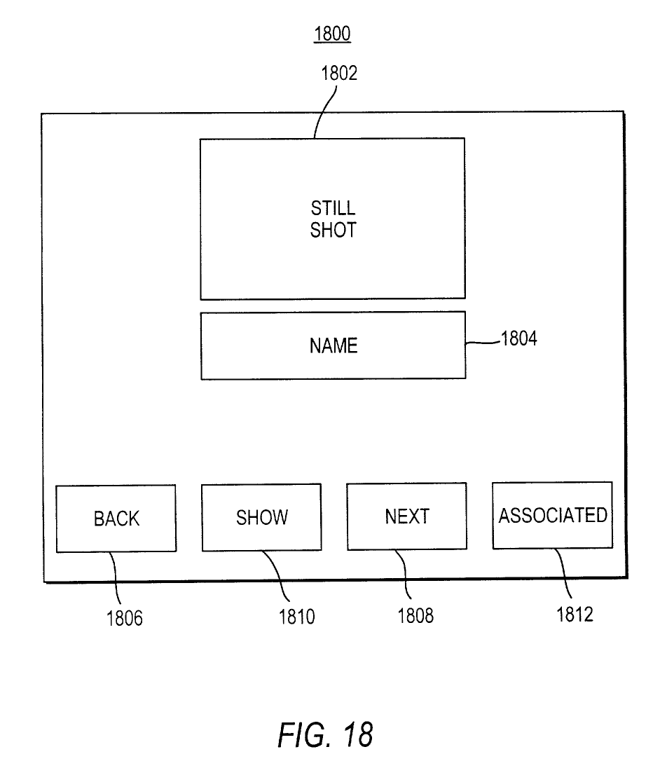

When the user selects a still shot, a display screen such as illustrative display screen 1800 of FIG. 18 may be displayed. As shown in FIG. 18, personal video recording system 100 may display the selected still shot in a portion of a display screen such as portion 1802. In another suitable embodiment, the still shot may be displayed in full screen. As shown in FIG. 18, the name of the still shot may also be displayed as name 1804. Personal video recording system 100 may provide the user with the ability to return to the screen previously displayed by, for example, selecting a link such as back link 1806. Selecting back link 1806 may also display a still shot or other information associated with the still shot currently displayed in portion 1802. For example, selecting back link 1806 may display a still shot that is one prior to the currently displayed still shot (shown in portion 1802) in a sequence of still shots. Similarly, selecting a next link such as next link 1808 may display a still shot that is next in a sequence of still shots.

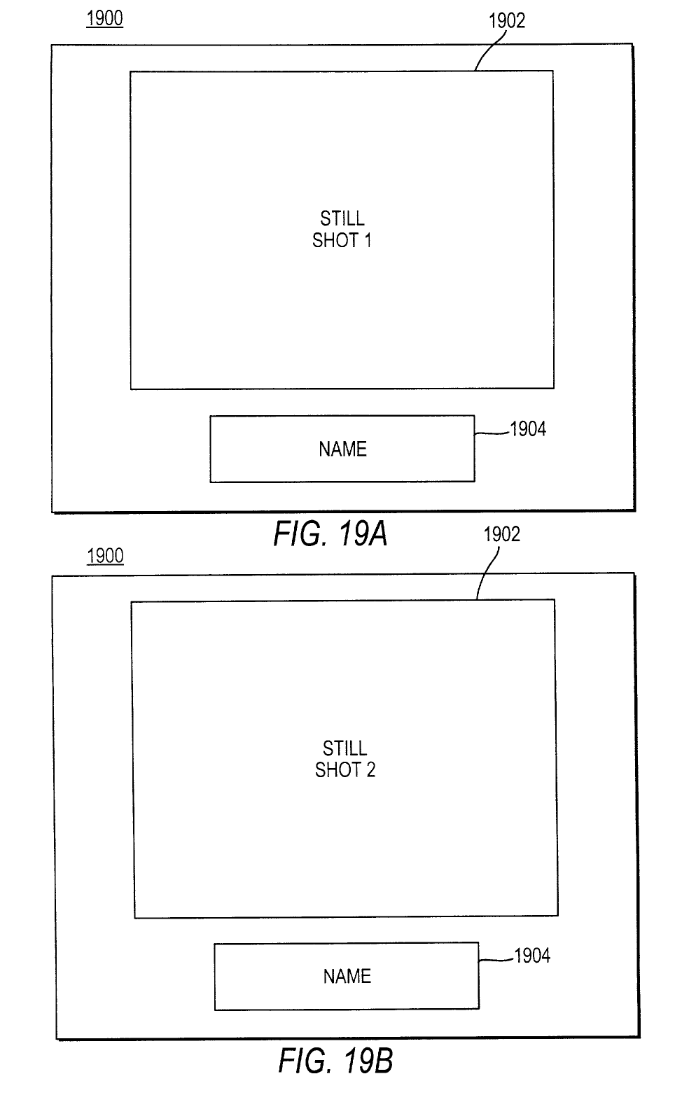

In one suitable embodiment, a slide show may be provided. By selecting a link such as show link 1810 or pressing a “show” key on remote control 180, personal video recording system 100 may generate a display such as illustrative display screen 1900 of FIGS. 19A and 19B. As shown in FIGS. 19A, a still shot may be displayed in a portion of a display screen such as portion 1902. In another suitable approach, a still shot may be displayed in full screen. The name of the still shot, such as name 1904, may also be displayed. After a pre-determined amount of time passes, or the user presses a “next” key or a “show” key on remote control 180 for example, the next still shot in a sequence of still shots may be displayed. For example, if the still shot displayed in FIG. 19A was displayed for thirty seconds, personal video recording system 100 may automatically display the next still shot in a sequence of still shots as shown in FIG. 19B.

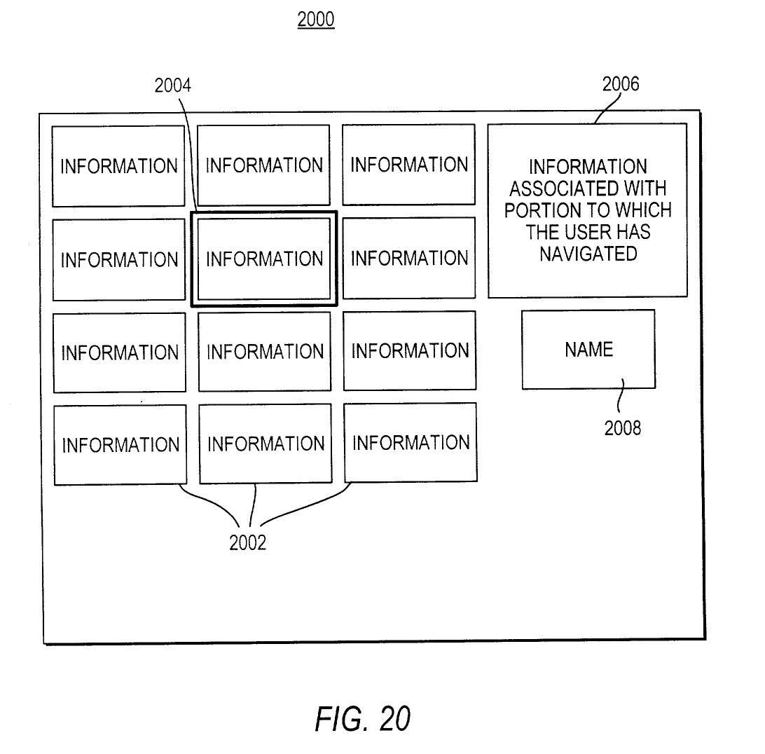

An associated link 1812 may also be provided in a display screen such as display screen 1800 such that upon selection of associated link 1812, still shots, video clips, or other associated information may be displayed on a display screen. Such a display screen is display screen 2000 of FIG. 20. As shown in illustrative display screen 2000, any suitable amount of still shots or other information may be displayed in portions of a display screen. Such portions are portions 2002. The still shots or other information displayed in portions 2002 may be, for example, thumb-nail sketches or scaled down displays of still shots, video clips (e.g., first frame of video clips), or other information. Personal video recording system 100 may provide the user with the ability to navigate among the portions by, for example, pressing the arrow keys on remote control 180. A highlight or indicator, such as highlight ring 2004, may be displayed around the portion to which the user has navigated. Upon navigating to a portion 2002, the thumb-nail sketch or scaled down display of a still shot, video clip, or other information associated with the portion to which the user has navigated may be displayed in a larger portion such as portion 2006. The name of the still shot or other information may also be displayed as name 2008. In an embodiment such as this, upon pressing a “show” key on remote control 180, a slide show may start. The first still shot to be displayed in the slide show may be the still shot of the portion 2002 to which the user has navigated (e.g., the portion surrounded by highlight ring 2004).

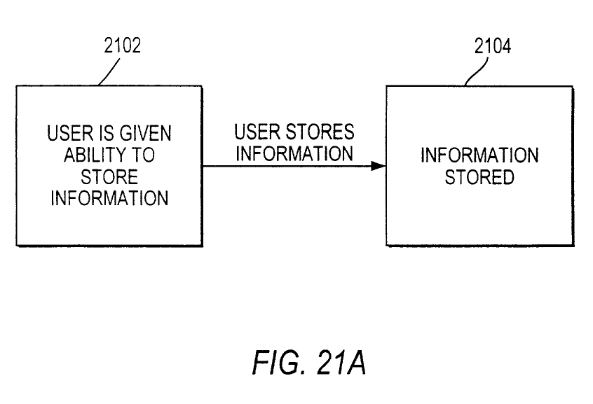

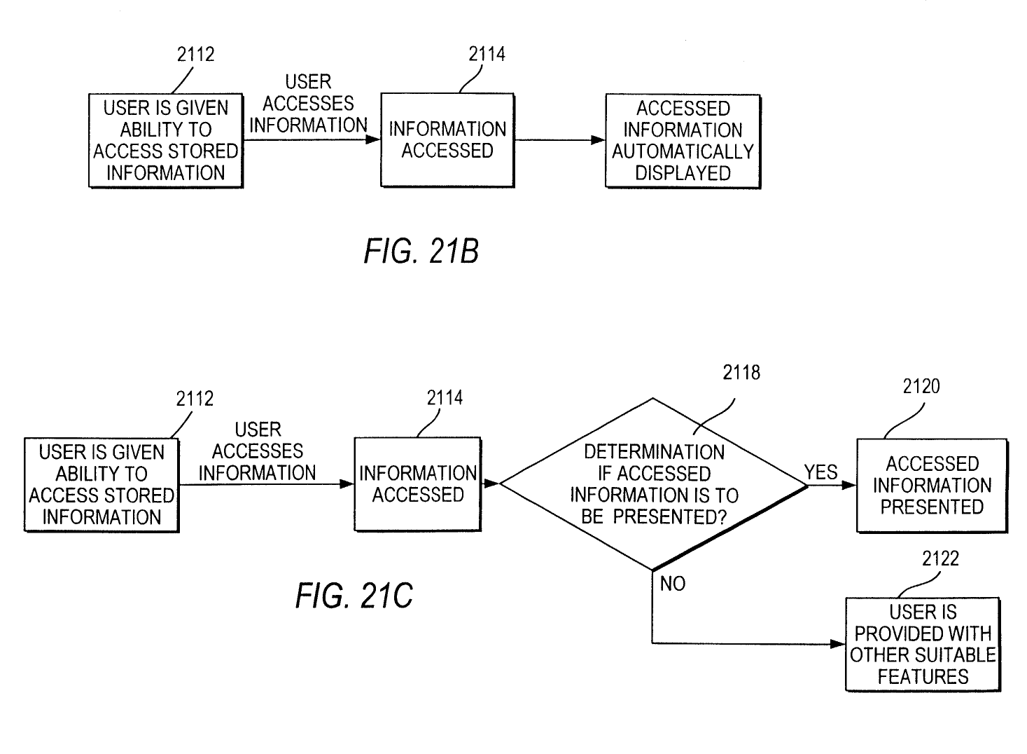

As shown in the illustrative flow charts of FIGS. 21A, 21B, and 21C, personal video recording system 100 may provide the user with the ability to store and access any information (e.g., video and audio feeds, compiled clips, still shots, slide shows). In the illustrative flow chart of FIG. 21A for example, the user may be given the ability to store information. This may occur at step 2102. When the user stores information, personal video recording system 100 may store the information at step 2104.

In the illustrative flow charts of FIGS. 21B and 21C, the user may be given the ability to access stored information and have that information presented on an output device (e.g., output device 146). At step 2112, personal video recording system 100 may provide the user with the ability to access any stored information (e.g., video and audio feeds, compiled clips, still shots, slide shows). When the user accesses information, personal video recording system 100 may access the information at step 2114. In the illustrative flow chart shown in FIG. 21B, the accessed information may automatically be presented on an output device (e.g., output device 146). This may occur at step 2116.

In another suitable embodiment, the accessed information may not automatically be presented as shown in the illustrative flow chart of FIG. 21C. Personal video recording system 100 may provide the user with the ability to access any stored information (e.g., video and audio feeds, compiled clips, still shots, slide shows) at step 2112. When the user accesses information, personal video recording system 100 may access the information at step 2114. Personal video recording system 100 may then make a determination if the information accessed at step 2114 is to be presented. This may occur at step 2118. If personal video recording system 100 determines that the accessed information is to be presented, the accessed information may then be presented on, for example, an output-device (e.g., output-device 146). This may occur at step 2120. If personal video recording system 100 determines that the accessed information is not to be presented, the accessed information may not be presented and personal video recording system 100 may provide the user with other suitable features. This may occur at step 2122.

Such suitable features may include editing information, deleting information, parentally controlling information, archiving information to another storage device, and transferring the information to a disk. Information transferred to a disk may be transferred to other user television equipment 130. Other suitable features may include providing one particular user television equipment 130 with the ability to access the information from another user television equipment 130. A user at first user television equipment 130 may communicate the information to, for example, other user television equipment 130, or any other suitable device. The communicated information may be processed and dealt with in any suitable way. For example, information communicated to a remote server by a first user television equipment 130 may be accessed by a second user television equipment 130.

In another suitable embodiment, information may be transferred between two geographically disparate systems using, for example, a dial-up connection, integrated services designated network (ISDN), digital subscriber lines (DSL), a local area network connection (LAN), a wide area network connection (WAN), or any other suitable connection. Personal video recording system 100 may provide the user with the ability to communicate any information to any suitable server or storage device. Information stored at a server or storage device may be downloaded by any suitable system. In order for information to be transferred to and from systems, a verification and/or a password may be required. Upon verification, information downloaded by or communicated to another system may be accessed by that system. That system may provide the user of that system with the ability to access the information and use it as desired.

Any other suitable approach may be used for two systems to share information. For example, a storage device may be maintained at only one system. The system at a second location may transfer its real-time video and audio feeds to the storage device at a first location using any suitable approach (e.g., wireless, Internet broadcast). Stored information may also be transferred to the first system using any suitable approach.

Users of remote user television equipment (e.g., user television equipment that the user is not actively using) may be provided with the ability to access information stored at local user television equipment. Information communicated by local user television equipment (e.g., to a remote server) may also be accessed by users of remote user television equipment. Verification may be required for users of remote user television equipment to access information stored at, or communicated by, local user television equipment.

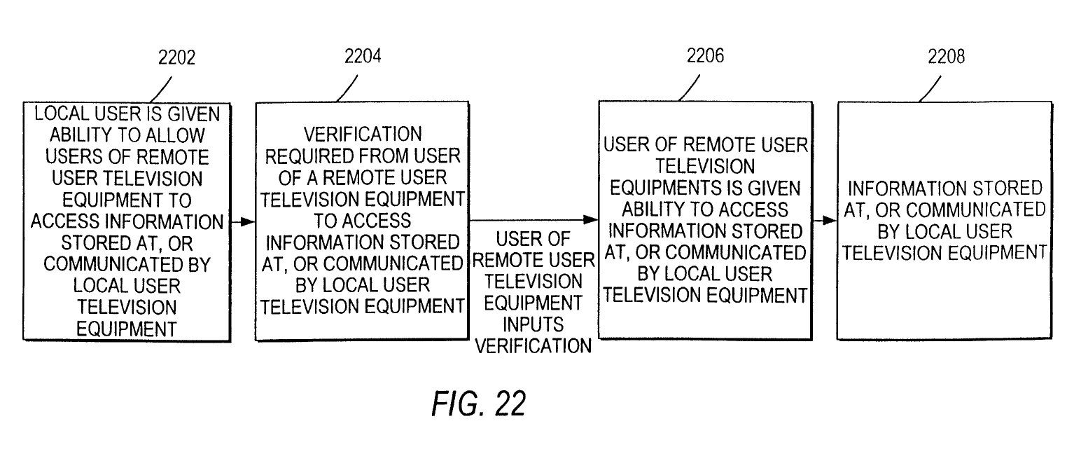

As shown in the illustrative flow chart of FIG. 22, verification may be required from a user of remote user television equipment to access information stored at local user television equipment or communicated by local user television equipment (e.g., communicated to a remote server). At step 2202, the user of local user television equipment may provide users of remote user television equipment with the ability to access information stored at, or communicated by, local user television equipment. At step 2204 verification may be required from users of remote user television equipment to access the information. When a user of a remote user television equipment inputs the proper verification to access the information, the remote user television equipment may provide the user of that user television equipment with the ability to access the information. This may occur at step 2206. Information stored at, or communicated by, local user television equipment may then be accessed by the remote user television equipment at step 2208.

A personal video recording system 100, or any component thereof, that lacks any information, equipment, application or any other necessary element that is needed to implement that personal video recording system 100 may share that information, equipment, application or any other necessary element with another system or any component thereof.

Personal video recording system 100 of the present invention may also be used for surveillance. For example, personal video recording system 100 may be used in connection with a user's home security system. In an embodiment in which personal video recording system 100 is used for surveillance, audio and video equipment (e.g., audio/visual equipment 150) may record only at certain times (e.g., at night, when the user's home security system is turned on) or when a sensor has been tripped for a pre-determined period of time. When sensors such as sensors 158 (FIG. 1) are tripped, the audio and video equipment of the system (e.g., audio/visual equipment 150) may begin recording. Sensors 158 may include sensors such as motion sensors, audio sensors, light sensors, lights-on, a door or window open sensor, heat sensors (e.g., fire, body heat), carbon monoxide sensors, smoke sensors, and weight sensors.

Personal video recording system 100 may automatically add an item to a hierarchical organizational tree (e.g., hierarchical organization tree 1010) in response to information being acquired after a sensor, such as sensor 158, is tripped. Addition of this item to the hierarchical organization tree may provide the user with the ability to directly access information acquired in response to a sensor 158 being tripped.

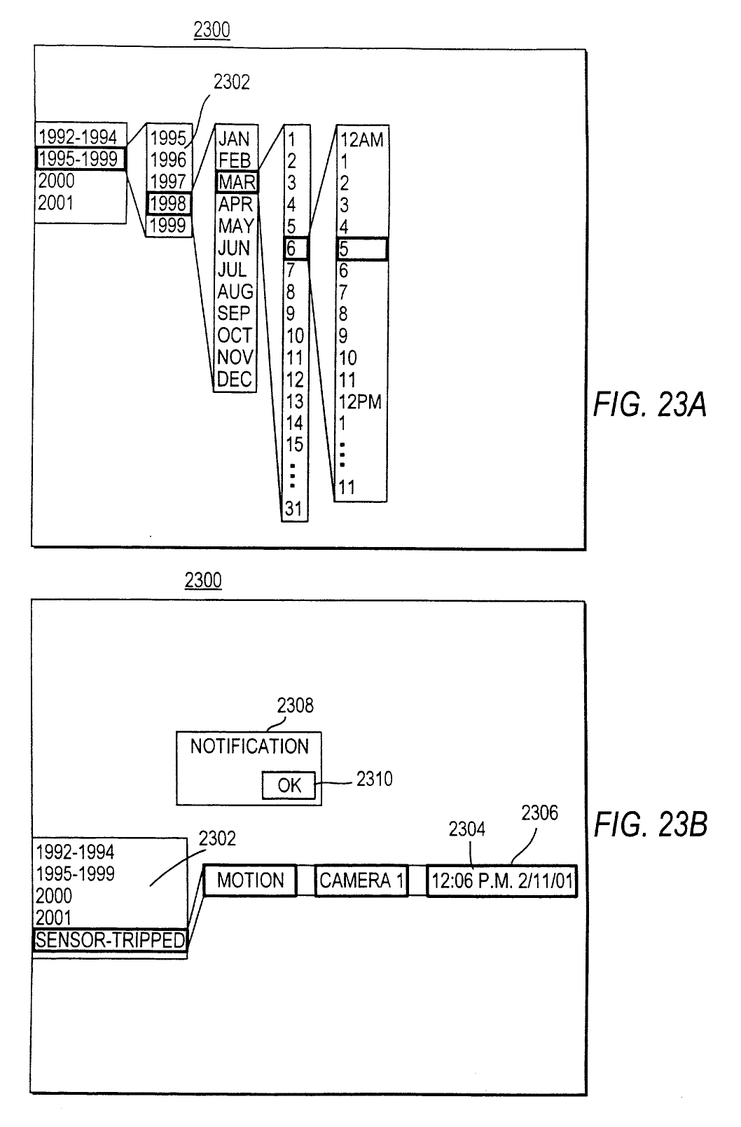

As shown in illustrative display screen 2300 of FIGS. 23A and 23B, an item (and corresponding directories) may be added to a hierarchical organization tree. FIG. 23A shows hierarchical organization tree 2302 before any one or more of sensors 158 are tripped. FIG. 23B shows a hierarchical organization tree 2302 after any one or more of sensors 158 are tripped. As a result of any one or more of sensors 158 being tripped, an item 2304 may be added to hierarchical organization tree 2302. When an item is added to a hierarchical organization tree, that item may be automatically navigated to. As shown in FIG. 23B, item 2304 has automatically been navigated to as indicated by highlight 2306 drawn around item 2304.

An automatic notification such as notification 2308 may be displayed on display screen 2300 to indicate to the user that a sensor 158 has been tripped. The user may not be able to continue using personal video recording system 100 until the user acknowledges a notification such as notification 2308. The user may acknowledge the notification by, for example, selecting an “Ok” button such as “Ok” button 2310 or by pressing an “Ok” key on remote control 180. Personal video recording system 100 may provide the user with the ability to turn notifications such as notifications 2308 off and on as desired.

If a thief entered into the user's home and stepped on a weight sensor, the audio and video equipment of the present invention (e.g., audio/visual equipment 150) may automatically begin recording. A silent alarm signal and any other information may be sent to an appropriate authority such as the police. The feeds from audio/video equipment 150 may also automatically be sent to a home surveillance service provider.

In another suitable embodiment, personal video recording system 100 may be time-based. Audio/visual equipment 150 may begin to acquire information starting at a pre-determined time. Audio/visual equipment 150 may stop acquiring information at another pre-determined time. For example, personal video recording system 100 may be used to monitor activity in a user's home when the user is not going to be home or sleeping. These examples are merely illustrative. Any suitable time-based surveillance may be used.

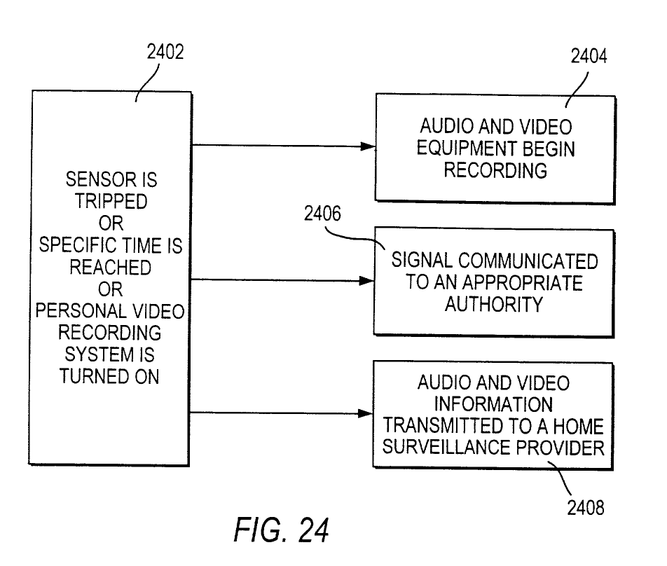

As shown in the illustrative flow chart of FIG. 24, personal video recording system 100 may record information, communicate a signal to an appropriate authority, and transmit information to a home surveillance provider when sensors such as sensors 158 are tripped, when personal video recording system 100 is turned on by the user, or when a specific time is reached. At step 2402, sensors may be tripped, personal video recording system 100 may be turned on by the user, or a specific time may be reached. Audio and video equipment may then begin recording at step 2404. At step 2406, a signal may be communicated to an appropriate authority. The audio and video information may also be transmitted to a home surveillance provider at step 2408.

Thus, a personal video recording system is provided. One skilled in the art will appreciate that the present invention can be practiced by other than the described embodiments, which are presented for purposes of illustration and not of limitation, and the present invention is limited only by the claims which follow.

What is claimed is:

1. A method for using a personal video recording system having user television equipment for acquiring video information comprising:
coupling at least one video capture device to a multi-media device;
acquiring video information using the video capture device; and
storing the video information on a storage device, wherein the storage device is coupled to the multi-media device.

2. The method of claim 1 wherein the multi-media device is selected from a group consisting of a set-top box, a personal video recorder, a television having an integrated set-top box, a WebTV box, a personal computer television (PC/TV), a handheld computing device, and any combination thereof.

3. The method of claim 1 further comprising:
coupling at least one audio capture device to the multi-media device;
acquiring audio information using the audio capture device; and
storing the audio information on the storage device.

4. The method of claim 1 further comprising:
accessing the video information; and
presenting the video information to a user.

5. The method of claim 4 wherein presenting the video information to a user comprises displaying the video information to the user on a display device.

6. The method of claim 1 further comprising providing a user with the ability to name the video information.

7. The method of claim 1 further comprising providing a user with the ability to name the video capture device.

8. The method of claim 1 further comprising providing a user with the ability to store the video information at any location in a file system in the storage device.

9. The method of claim 1 wherein the storage device is located in the home of a user.

10. The method of claim 1 wherein the storage device is a remote shared server.

11. The method of claim 1 further comprising allowing a user to restrict access to the video information.

12. The method of claim 1 further comprising providing a user with the ability to edit the video information.

13. The method of claim 1 wherein the acquiring the video information takes place as a result of at least one sensor being tripped.

14. The method of claim 13 further comprising communicating a signal to an appropriate authority as a result of at least one sensor being tripped.

15. The method of claim 1 further comprising providing the user with the ability to share video information with users of other user television equipment.

16. The method of claim 1 further comprising providing a guidance application to a user, wherein the guidance application allows the user to navigate among the video information.

17. The method of claim 1 wherein the video information comprises one or more still frames.

18. The method of claim 1 wherein the video information is stored on an auxiliary device.

19. A method for using a personal video recording system having user television equipment for acquiring and presenting real-time video information to a user comprising:
coupling at least one video capture device to a multi-media device;
acquiring video information using the video capture device; and
presenting the video information in real-time to the user via at least one display device wherein the display device is coupled to the multi-media device.

20. The method of claim 19 wherein the multi-media device is selected from a group consisting of a set-top box, a personal video recorder, a television having an integrated set-top box, a WebTV box, a personal computer television (PC/TV), a handheld computing device, and any combination thereof.

21. The method of claim 19 further comprising:
coupling at least one audio capture device to the multi-media device;
acquiring audio information using the audio capture device; and
presenting the audio information in real-time to the user via at least one audio output device wherein the audio output device is coupled to the multi-media device.

22. The method of claim 19 further comprising providing the user with the ability to name the video information.

23. The method of claim 19 further comprising providing the user with the ability to name the video capture device.

24. The method of claim 19 further comprising providing the user with the ability to store the video information at any location in a file system in a storage device.

25. The method of claim 24 wherein the storage device is located in the home of a user.

26. The method of claim 24 wherein the storage device is a remote server.

27. The method of claim 19 further comprising allowing the user to restrict access to the video information.

28. The method of claim 19 further comprising providing a user with the ability to edit the video information.

29. The method of claim 19 wherein the acquiring the video information takes place as a result of at least one sensor being tripped.

30. The method of claim 19 further comprising communicating a signal to an appropriate authority as a result of at least one sensor being tripped.

31. The method of claim 19 further comprising providing the user with the ability to share video information with users of other user television equipment.

32. The method of claim 19 further comprising providing a guidance application to a user, wherein the guidance application allows the user to navigate among the video information.

33. The method of claim 19 wherein the video information comprises one or more still frames.

34. The method of claim 19 wherein the video information is stored on an auxiliary device.

35. A method for providing a user with the ability to manipulate audio and video information using a personal video recording system having a guidance application and user television equipment comprising:
acquiring the audio and video information using at least one audio capture device and at least one video capture device, respectively, wherein the audio capture device and the video capture device are included in the user television equipment; and
providing to the user an interface using the guidance application, wherein the user is given the ability to use the interface to manipulate the audio and video information.

36. The method of claim 35 further comprising providing the user with the ability to name the video information.

37. The method of claim 35 further comprising providing the user with the ability to name the video capture device.

38. The method of claim 35 further comprising providing the user with the ability to store the video information at any location in a file system in a storage device.

39. The method of claim 38 wherein the storage device is located in the home of a user.

40. The method of claim 38 wherein the storage device is a remote server.

41. The method of claim 35 further comprising providing parental control features to lock and unlock the video information.

42. The method of claim 35 further comprising providing a user with the ability to edit the video information.

43. The method of claim 35 further comprising providing the user with the ability to edit the video information using a third-party application.

44. The method of claim 35 further comprising displaying at least one selectable item corresponding to video information.

45. The method of claim 44 further comprising automatically displaying the selectable item in response to at least one sensor being tripped.

46. The method of claim 35 further comprising providing the user with the ability to share video information with users of other user television equipment.

47. The method of claim 35 wherein the video information comprises one or more still frames.

48. The method of claim 35 wherein the video information is stored on an auxiliary device.

49. A personal video recording system having user television equipment for acquiring video information comprising:
a multi-media device;
at least one video capture device coupled to the multi-media device; and
a storage device coupled to the multimedia device, wherein video information acquired from the video capture device is stored in the storage device.

50. The personal video recording system of claim 49 wherein the multi-media device is selected from a group consisting of a set-top box, a personal video recorder, a television having an integrated set-top box, a WebTV box, a personal computer television (PC/TV), a handheld computing device, and any combination thereof.

51. The personal video recording system of claim 49 further comprising at least one audio capture device coupled to the multi-media device, wherein the audio information acquired from the audio capture device is stored in the storage device.

52. The personal video recording system of claim 49 further comprising a display device that is used to present the video information to a user.

53. The personal video recording system of claim 49 wherein the system is configured to provide a user with the ability to name the video information.

54. The personal video recording system of claim 49 wherein the system is configured to provide a user with the ability to name the video capture device.

55. The personal video recording system of claim 49 wherein the system is configured to provide a user with the ability to store the video information at any location in a file system in the storage device.

56. The personal video recording system of claim 49 wherein the storage device is located in the home of a user.

57. The personal video recording system of claim 49 wherein the storage device is a remote shared server.

58. The personal video recording system of claim 49 wherein the system is configured to provide a user with the ability to restrict access to the video information.

59. The personal video recording system of claim 49 wherein the system is configured to provide a user with the ability to edit the video information.

60. The personal video recording system of claim 49 further comprising at least one sensor, wherein the video capture device acquires video information in response to at least one sensor being tripped.

61. The personal video recording system of claim 49 wherein a signal is communicated to an appropriate authority in response to at least one sensor being tripped.

62. The personal video recording system of claim 49 wherein the system is configured to provide a user with the ability to share video information with users of other user television equipment.

63. The personal video recording system of claim 49 wherein the system is configured to provide a guidance application to a user, wherein the guidance application allows the user to navigate among the video information.

64. The personal video recording system of claim 49 wherein the video information comprises one or more still frames.

65. The personal video recording system of claim 49 wherein the video information is stored on an auxiliary device.

66. A personal video recording system having user television equipment for acquiring and presenting real-time information to a user comprising:
a multi-media device;
at least one video capture device coupled to the multi-media device; and
at least one display device coupled to a multi-media device on which video information acquired from the video capture device is presented in real-time to the user.

67. The personal video recording system of claim 66 wherein the multi-media device is selected from a group consisting of a set-top box, a personal video recorder, a television having an integrated set-top box, a WebTV box, a personal computer television (PC/TV), a handheld computing device, and any combination thereof.

68. The personal video recording system of claim 66 further comprising at least one audio capture device coupled to the multi-media device; and
at least one audio output device through which audio information acquired from the audio capture device is presented in real-time to the user.

69. The personal video recording system of claim 66 wherein the system is configured to provide the user with the ability to name the video information.

70. The personal video recording system of claim 66 wherein the system is configured to provide the user with the ability to name the video capture device.

71. The personal video recording system of claim 66 wherein the system is configured to provide the user with the ability to store the video information at any location in a file system in a storage device.

72. The personal video recording system of claim 71 wherein the storage device is located in the home of a user.

73. The personal video recording system of claim 71 wherein the storage device is a remote server.

74. The personal video recording system of claim 66 wherein the system is configured to provide the user with the ability to restrict access to the video information.

75. The personal video recording system of claim 66 wherein the user is provided with the ability to edit the video information.

76. The personal video recording system of claim 66 further comprising at least one sensor, wherein the video capture device acquires video information in response to at least one sensor being tripped.

77. The personal video recording system of claim 66 wherein a signal is communicated to an appropriate authority in response to at least one sensor being tripped.

78. The personal video recording system of claim 66 wherein the user is provided with the ability to share video information with users of other user television equipment.

79. The personal video recording system of claim 66 wherein the system is configured to provide a guidance application to a user, wherein the guidance application allows the user to navigate among the video information.

80. The personal video recording system of claim 66 wherein the video information comprises one or more still frames.

81. The personal video recording system of claim 66 wherein the video information is stored on an auxiliary device.

82. A personal video recording system for providing a user with the ability to manipulate audio and video information using a personal video recording system having a guidance application and user television equipment:
at least one audio capture device and at least one video capture device configured to capture audio and video information respectively, wherein the audio capture device and the video capture device are included in the user television equipment;
a user interface is provided to the user using the guidance application and wherein the user is given the ability to use the interface to manipulate the audio and video information.

83. The personal video recording system of claim 82 wherein the system is configured to provide the user with the ability to name the video information.

84. The personal video recording system of claim 82 wherein the system is configured to provide the user with the ability to name the video capture device.

85. The personal video recording system of claim 82 wherein the system is configured to provide the user with the ability to store the video information at any location in a file system in a storage device.

86. The personal video recording system of claim 85 wherein the storage device is located in the home of a user.

87. The personal video recording system of claim 85 wherein the storage device is a remote server.

88. The personal video recording system of claim 82 wherein the system is configured to provide the user with the ability to restrict access to the video information.

89. The personal video recording system of claim 82 wherein the system is configured to provide the user with the ability to edit the video information.

90. The personal video recording system of claim 89 wherein the system is configured to provide the user with the ability to edit the video information using a third-party application.

91. The personal video recording system of claim 82 wherein the display device displays at least one selectable item corresponding to video.

92. The personal video recording system of claim 91 wherein the display device displays the selectable item in response to at least one sensor being tripped.

93. The personal video recording system of claim 82 wherein the system is configured to provide the user with the ability to share video information with users of other user television equipment.

94. The personal video recording system of claim 82 wherein the video information comprises one or more still frames.

95. The personal video recording system of claim 82 wherein the video information is stored on an auxiliary device.
